(19) United States
(12) Patent Application Publication
(10) Pub. No.: US 2013/0036348 A1
(43) Pub. Date: Feb. 7, 2013

(54) Systems and Methods for Identifying a Standard Document Component in a Community and Generating a Document Containing the Standard Document Component

(71) Applicant: James G. Hazard, Woodside, CA (US)

(72) Inventor: James G. Hazard, Woodside, CA (US)

(21) Appl. No.: 13/535,324

(22) Filed: Jun. 27, 2012

Related U.S. Application Data
(60) Provisional application No. 61/501,417, filed on Jun. 27, 2011.

(51) Int. Cl. G06F 17/00

(52) U.S. Cl. 715/230

(57) ABSTRACT

Disclosed herein is a system comprising a document import engine, a document tagging engine, and a document assembly engine. The document import engine may be configured to import a first document, identify at least one document component within the first document, and generate a hierarchical data structure including a node containing the at least one document component. The document tagging engine may be configured to receive, from a first member of a community, an annotation of the at least one document component, and associate with the node metadata including the identification. The document assembly engine may be configured to receive, from a second member of the community, a request to generate a second document containing a component associated with the annotation, and generate the second document containing the at least one document component. Disclosed herein is a related method.

### CROSS-REFERENCE TO RELATED APPLICATIONS

The present application claims benefit of U.S. Provisional Patent Application No. 61/501,417, filed Jun. 27, 2011, entitled “Methods and Systems for Identifying, and Automatically Generating Documents Containing, Standard Document Components,” having as First Named Inventor/Applicant Name, James G. Hazard. U.S. Provisional Patent Application No. 61/501,417 is hereby incorporated by reference herein.

### BACKGROUND

1. Field of the Invention(s)

The field generally relates to computer systems and methods. More particularly, the field relates to computer systems and methods used to generate and control standardized electronic documents.

2. Description of Related Art

The field of document processing and creation has developed software and technological processes in an effort to make it easier for people to draft and prepare legal, business and other documents. In some areas, such as legal contract drafting, form documents are used as templates to help a lawyer avoid drafting inconsistencies and otherwise increase drafting efficiency. When a document is created, there are many situations in which some parts of the document that are regarded by the author and readers as generally applicable to that kind of document, and other parts are regarded as specific to a particular use. This is true of many documents such as applications, proposals, court filings and contracts. In contracts, for example, generally applicable portions may include intellectual property provisions and dispute resolution provisions, while specific portions may include price, party names and options. The distinction between specific and general often occurs on multiple levels. For example, a contract usually has provisions addressing issues that are common to nearly all contracts (e.g., choice of law and dispute resolution), other provisions that are common to contracts dealing with the kind of operation (e.g., license agreements), and more narrow or situation-specific provisions (such as patent licenses, contracts governed by particular state law, and contracts made by a particular organization). In many situations, including most contract negotiation settings, the text is often handled inefficiently because the specific and general issues are mixed together with no distinction as to the layer of generality, or only a bipolar distinction between transaction-specific issues and general issues. Participants are often required to read or reread texts to confirm that particular clauses state conventional ideas in conventional ways. To read and draft a contract with care and understanding requires great knowledge and training.

Some systems provide functionality in which parties could incorporate conventional agreement text hosted on a website purely by incorporating such text by reference to the website. However, pure incorporation by reference to a website can be difficult for lawyers to adopt in their practices, does not provide a powerful incentive to contribute, and requires higher levels of standardization and a significant change in practice habits. Form agreements can help the author, but are typically handled manually and may not help the readers. Form agreements often involve redundancy of standard provisions from one form to another, because they are not tailored to a particular area of use. Existing document assembly systems can be useful for highly repetitive situations, but are prohibitively difficult for non-specialists to program and understand. As a result, contract experts and parties cannot easily understand what is included in the resulting document unless they read the result, and have difficulty contributing new solutions to a broader knowledge base. Standardized terms and agreements depend on intense collaboration or a dominant participant to achieve standardization.

The foregoing and other objects and advantages will be appreciated more fully from the following further description thereof, with reference to the accompanying drawings

### SUMMARY

In various embodiments, a system may comprise a document import engine configured to import a first document. The document import engine may be configured to identify at least one document component within the first document. The document import engine may also be configured to generate a hierarchical data structure including a node containing the at least one document component. The system may further comprise a document tagging engine. The document tagging engine may be configured to receive, from a first member of a community, an annotation of the at least one document component. The document tagging engine may also be configured to associate metadata, including the identification, with the node. The system may include a document assembly engine. The document assembly engine may be configured to receive, from a second member of the community, a request to generate a second document containing a component associated with the annotation. The document assembly engine may also be configured to generate the second document containing the at least one document component.

In some embodiments, the document tagging engine may be configured to receive, from each of a plurality of members of the community, an identification of the at least one document component as a standard document component. In various embodiments, the document tagging engine may be configured to associate metadata with the at least one document component upon receiving, from each of a plurality of community members, an identification of the at least one document component as a standard document component.

In various embodiments, the document tagging engine may be configured to associate the metadata with the at least one document component, the metadata including an identification of the first member of the community. In some embodiments, the document tagging engine, au be configured to receive, from the first member of the community, an identification of a modification of the at least one document component and an identification of the modified at least one document component as a standard document component.

In some embodiments, the document import engine may be configured to generate a second node within the hierarchical data structure, the second node containing a modified at least one document component. Further, the document tagging engine may be configured to associate additional metadata with the second node, the additional metadata including an identification of the first member of the community. Moreover, the document tagging engine may be configured to associate additional metadata with the second node, the additional metadata including an identification of the modified at least one document component as a standard in the community.

In various embodiments, the document import engine may be configured to distribute at least one node of the hierarchical data structure to a plurality of members of the community. In some embodiments, the document import engine may be configured to search, by at least one member of the community, the hierarchical data structure for the node. In some embodiments, the document assembly engine may be configured to receive, from the second member of the community, content to include in the second document.

In some embodiments, the document assembly engine may be configured to receive, from the second member of the community, additional metadata including an identification of a type of content to include in the second document. In various embodiments, the document assembly engine may be configured to receive, from the second member of the community, an identification of a node within the hierarchical data structure to include in the second document. In some embodiments, the document assembly engine may be configured to generate a second node in the hierarchical data structure containing at least one document component of the second document.

In various embodiments, the document assembly engine may be configured to recommend to the second member of the community inclusion, in the second document, of a second node within the hierarchical data structure. In some embodiments, the document tagging engine may comprise a user interface allowing the first member of the community to identify the node in the hierarchical data structure as a standard component in the community. In some embodiments, the document tagging engine may comprise a user interface allowing the first member of the community to annotate the node in the hierarchical data structure.

In some embodiments, a method may comprise: importing a first document; identifying at least one document component within the first document; generating a hierarchical data structure including a node containing the at least one document component; receiving, from a first member of a community, an annotation of the at least one document component; associating metadata, including the identification, with the node; receiving, from a second member of the community, a request to generate a second document containing a component associated with the annotation; and generating the second document containing the at least one document component.

### BRIEF DESCRIPTION OF THE DRAWINGS

FIG. 1A is a flow diagram of an example of a method of assembling a document, according to some embodiments.

FIG. 1B is diagram of an example of a document assembly system, according to some embodiments.

FIG. 2 is a diagram of an example of binder and data pages that can be utilized by a document assembly system, according to some embodiments.

FIG. 3A is a diagram of an example of a document being processed in accordance with an example of a document assembly method, according to some embodiments.

FIG. 3B is a diagram of an example of a document being processed in accordance with an example of a document assembly method, according to some embodiments.

FIG. 4 is a diagram of an example of a user interface display in accordance with an example of a document assembly method, according to some embodiments.

FIG. 5 is a diagram of an example of a user interface display in accordance with an example of a document assembly method, according to some embodiments.

FIG. 6 is a diagram of an example of a user interface display in accordance with an example of a document assembly method, according to some embodiments.

FIG. 7 is a diagram of an example of a user interface display in accordance with an example of a document assembly method, according to some embodiments.

FIG. 8 is a diagram of an example of a method for versioning generated pages, such as data pages, according to some embodiments.

FIG. 9 is a Venn diagram showing examples of relationships of different collections of data files, according to some embodiments.

FIG. 10 is a diagram of an example of a user interface display in accordance with an example of a document assembly method, according to some embodiments.

FIG. 11 is a diagram of an example of a user interface display in accordance with an example of a document assembly method, according to some embodiments.

FIG. 12 is a diagram of an example of a network system configured to serve a document assembly system, according to some embodiments.

FIG. 13 is a diagram of an example of a system for identifying a standard document component in a community and automatically generating a document containing the standard document component, according to some embodiments.

FIG. 14 is a diagram of an example of a method for identifying a standard document component in a community and automatically generating a document containing the standard document component, according to some embodiments.

FIG. 15 is a diagram of an example of a digital device according to some embodiments.

### DETAILED DESCRIPTION

Described herein are systems and methods for generating documents by allowing a user to specify a form page and a priority-ordered list of data pages. The form page provides an outline for the document. Additionally, the form page includes field indicators that are used during document generation to populate the data pages with content. For example, a field indicator may be associated with specific content data on the form page; throughout the data pages, where the field indicator appears, a component of the system may replace the field indicator with the content identified on the form page. In one embodiment, when multiple fields in the data pages may be matched with a particular field indicator, the highest priority field (as identified, e.g., according to the priority-ordered list of data pages) is used to provide content for the document.

The document assembly systems and techniques described herein may be advantageously applied when an individual or organization wants to generate one or more documents, all at once or at different times, and portions of the documents are similar to or the same as each other, or are similar to or the same as a previously-generated document. Some aspects of the system may be thought of as providing redundancy reduction by “factoring out” the repeated portions of a collection of documents. A user of this system can confirm that portions of the document conform to a precedent already existing in the system that the user is already aware of, or trusts because of the opinions or use by others, which reduces the need for reading and re-reading.

These systems and techniques also allow the separation of the transaction-specific portions (e.g., deal terms) from portions that are re-used from one document to the next (e.g., boilerplate clauses). Further, customizable collections of re-used portions can be assembled corresponding to different “use cases” (e.g., license of software only, or software and content), or by contributing author (e.g., intellectual property representations and warranties written or validated by an individual or organization). Using the systems and techniques disclosed herein, users can organize, customize and generate documents with great flexibility, according to their needs.

Systems and techniques for network-based document assembly are also disclosed herein, in which a multiplicity of users at remote locations can collectively edit a document, agree on the content and organization of the document, and generate the document. Systems and techniques are also provided for maintaining an inventory of documents and analyzing the inventory for patterns and statistics of use. A user accesses this inventory, along with the patterns and statistics, to guide his or her own document assembly process, thus benefiting from the knowledge, diligence and experience of others. The systems and techniques disclosed herein are particularly applicable to contract texts. An inventory of attested text, which comes from a known source, could enable longer, more structured documents without overloading the reader. Additionally, in legal document contexts, some interpretation attacks that can be made on text agreed in the intimacy of a two party negotiation are less likely to succeed when the terms are understood to be standards. The “intent” of a community can more easily “found” to be sensible than can the intent of two persons. The systems and techniques are also applicable to other document drafting situations, such as wills, court filings, probate papers, or non-legal documents such as advertising, news, media articles, reports and papers.

Described herein are systems and methods for generating documents by allowing a user to specify an electronic document “binder,” which can be edited and used to generate a document. In some aspects, the binder is a presentation arrangement that represents the data pages used in the assembly of a document, and serves as a conceptual aid for the user, who can conceptualize the process of document assembly as selecting and customizing data pages in a particular binder. In particular, the binder includes a form page and a priority-ordered list of data pages. The form page provides an “outline” for the document by including field indicators that are replaced with content during document generation by matching the field indicators of the form page with fields in the data pages. When multiple fields in the data pages may be matched with a particular field indicator, the highest priority field (according to the priority-ordered list of data pages) is used to provide content for the document.

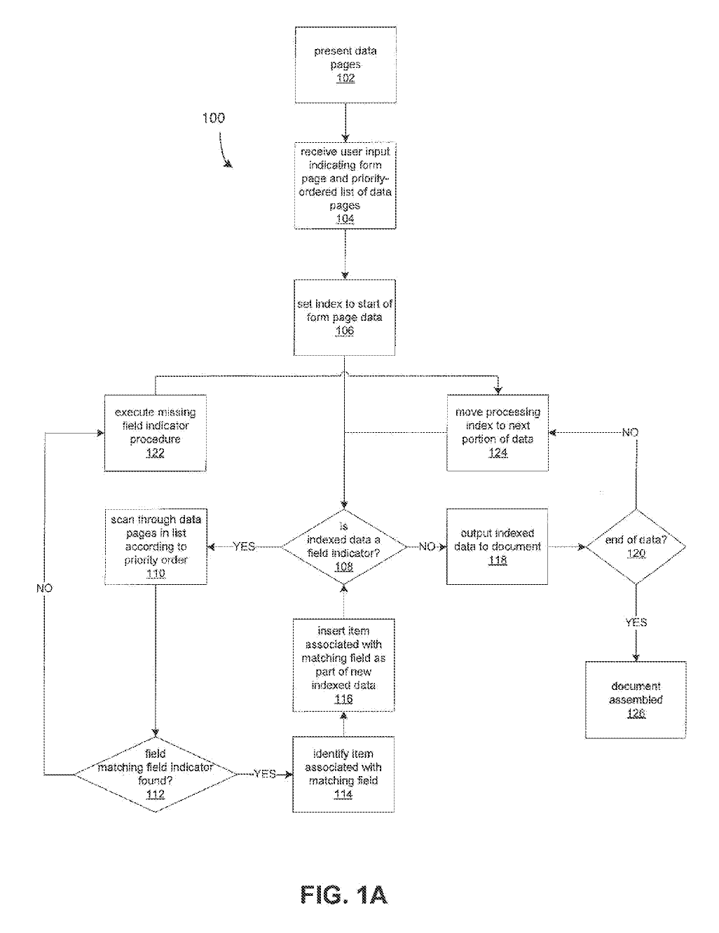

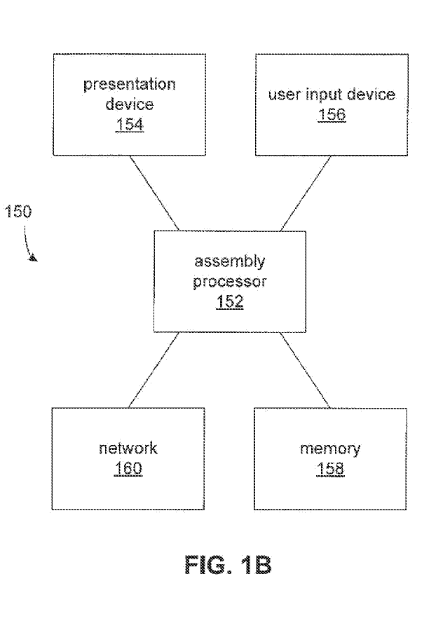

FIG. 1A is a flow diagram of an example of a method 100 of assembling a document, according to some embodiments. FIG. 1B is diagram of an example of a document assembly system 150, according to some embodiments. The document assembly system 150 may be configured to perform one or more steps of the method 100. In one embodiment, the method 100 may use fields and field indicators to create a document binder and generate a document.

The document assembly system 150 includes an assembly processor 152 communicably coupled to a presentation device 154, a user input device 156, a memory 158, and optionally a network 160. The presentation device 154 may include one or more of a visual display (e.g., a computer monitor, a television screen, a touch pad display, a handheld device display), a tactile display (e.g., a Braille display), an electronic speaker or other audio output, or any other device capable of presenting information to a user. The user input device 156 may include one or more of a mouse, trackball, remote control, touch screen, voice recognition system, or any other input device. The memory 158 may include one or more of a solid-state memory, a hard drive, network-based storage, smart cards or EEPROMs, memory media such as compact discs, DVDs and optical storage devices, or any other electronic memory. The communicable coupling between the elements of the document assembly system 150 may include one or more types of communication, including wired communication, wireless communication, Ethernet, telephone, satellite, and optical communication, as well as any other known communication type. The assembly processor 152 may include any processing device (such as one or more analog or digital microprocessors, personal computers or handheld computing devices, or network servers) configured to carry out the document assembly techniques described herein, including the method illustrated by the flow diagram 100 of FIG. 1A.

At the step 102 of the flow diagram 100, a plurality of data pages is presented to a user via the presentation device 154. Each data page is stored as an electronic data structure, which may be included in an electronic database, a web page, an electronic file, or a portion of an electronic file. These data structures may be stored locally to the user, or remotely, and may be accessed via a wired or wireless communications network such as the network 160 (e.g., the Internet). A data page includes electronically-represented data such as text, images, video, audio, hyperlinks, animations, address cards, applications, mixed media, and can include a combination of multiple types of electronically-represented data. For ease of illustration, the data pages described herein include text data, but any electronically-represented data (such as images and video) may be used with the document assembly systems and techniques disclosed herein. The plurality of data pages is presented to a user via the presentation device 154. Presenting a data page may include directly presenting the data included in the data page (e.g., the source code for a computer application), presenting a formatted version of the data included in the data page (e.g., a rendered version of RTF or HTML data, or other data written in a mark-up language such as wiki mark-up), presenting a title of the data page, presenting a description of the data page, presenting an icon or image representing the data page, presenting a directory or category of data pages, or any other way of indicating the data page to a user. In certain embodiments, the step 102 is performed by presenting a list or directory of data pages available to a user via a computer display. Presenting a data page may also include identifying a data page that has been created by a user (e.g., using a word processing or text entry application).

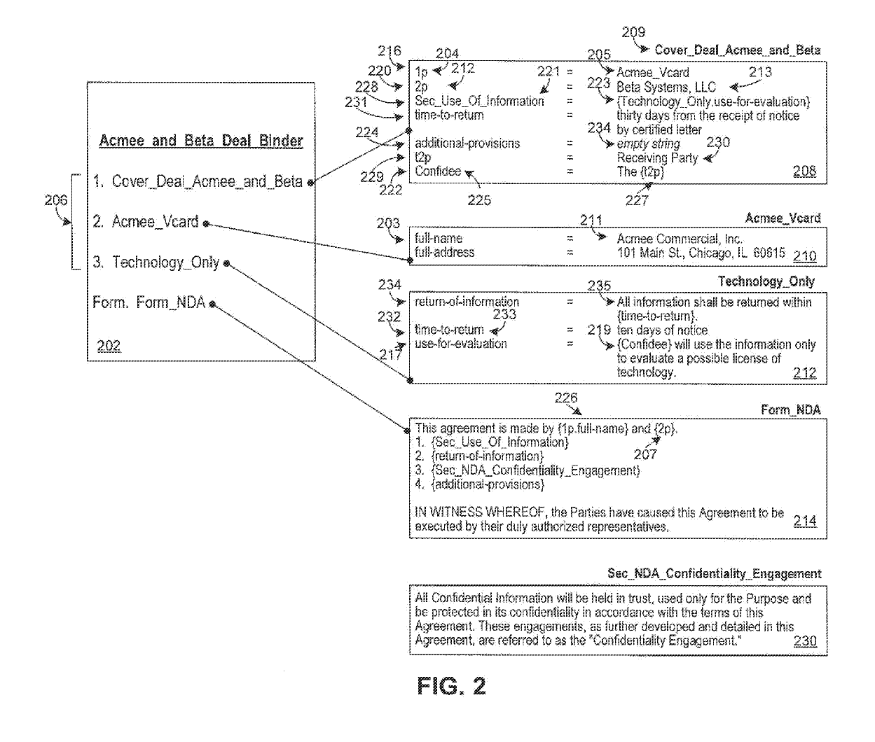

Each data page in the plurality of data pages presented at the step 102 includes at least one field. As used in this disclosure, a field is a data structure that includes at least a field name and an associated item. FIG. 2 is a diagram of an example of binder and data pages that can be utilized by a document assembly system, according to some embodiments. In the example of FIG. 2, data pages can include a data page 208, which has a name 209

(“Cover_Deal_Acmee_and_Beta”) and seven fields. The field 216 has a field name 204 (“1p”), designating the first party in a contract, and an associated item 205 (“Acmee_Vcard”), which indicates a “business card” data page that includes the name and address of the first party.

As illustrated by the field 220 of the data page 208, which has a field name 212 (“2p”) and an associated item 213 (“Beta Systems, LLC”), the associated item can include content (such as data or representations of data to be included in the assembled document). The associated item in a field can also include a field indicator, which is an indicator, such as a pointer, reference or portion of a pointer or reference, to another field in the same data page or in a different data page to which a user can look to obtain content (or another field indicator of yet another field). The assembly processor 152 distinguishes a field indicator from content by particular formatting, text mark-up of the form or page data, the context in which the field indicator is used during document assembly, or inclusion in a particular data structure. In certain implementations, a field indicator is a string of text (which may include spaces) demarcated by predetermined escape characters. For example, the field 228 of the data page 208 has a field name 221 (“Sec_Use_Of_Information”) and an associated item 223 (“{Technology_Only.use-for-evaluation}”) that is a field indicator demarcated by curly braces that serve as the escape characters. The escape characters allow a user to readily distinguish content from field indicators, and are used by the assembly processor 152 during document generation as described below.

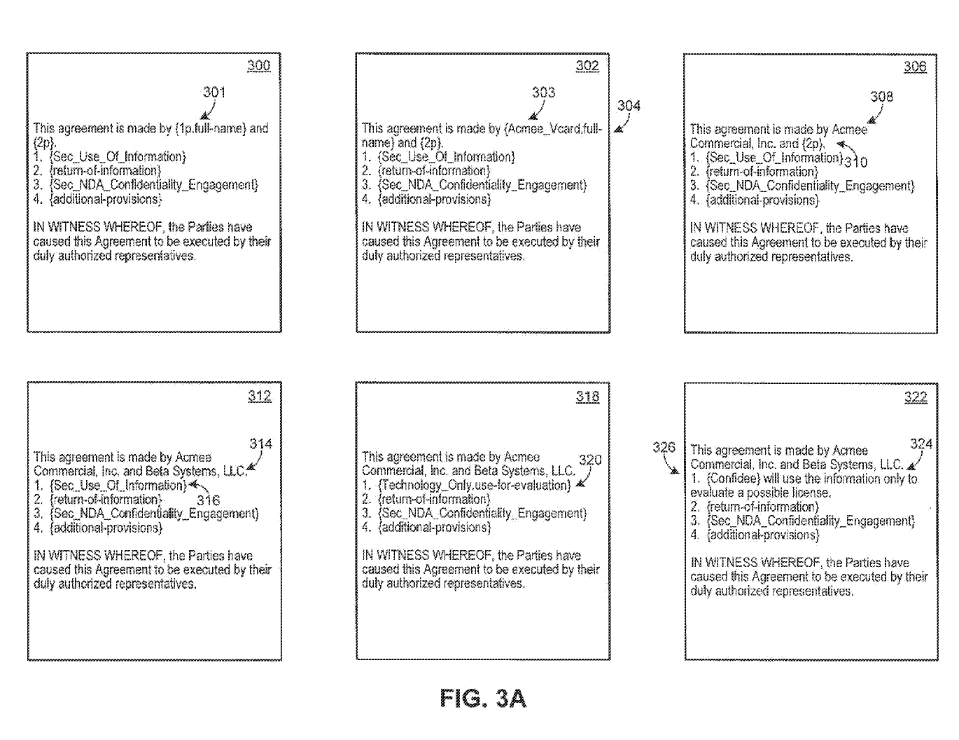

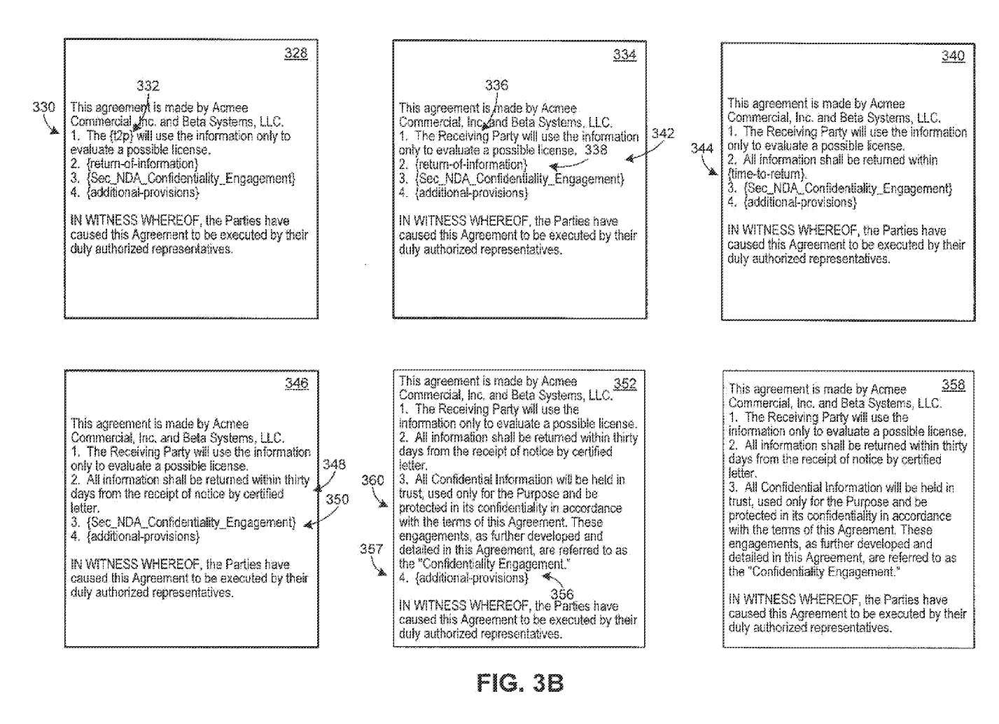

Additional delimiter characters can be used within a field indicator to provide additional information regarding the field indicated by the field indicator. For example, the field indicator 223 includes a period character “.” that separates the text string “Technology_Only” and the text string “use-for-evaluation”. The assembly processor 152 interprets the field indicator 223 as indicating a field with a field name that matches “use-for-evaluation” within a data page with a name that matches “Technology_Only”. Any data structure may be used for the fields and field indicators described herein, provided the assembly processor 152 is configured to recognize and process the data structures as desired. For example, the assembly processor 152 may be configured to interpret a field indicator of the form “{x.y}” as indicating a data page named “x” and a field named “y”. In certain implementations, one or more of “x” and “y” may themselves be field indicators or portions of field indicators, and may be processed as a field indicator by the assembly processor 152. For example, the assembly processor 152 may be configured to process the “x” of “{x.y}” as a field indicator on its own, but not process the “y” of “{x.y}” as a field indicator on its own (an example is described in the document assembly example illustrated by FIG. 3, with reference to the intermediate pages A 300, B 302 and C 306). FIG. 3A is a diagram of an example of a document being processed in accordance with an example of a document assembly method, according to some embodiments. FIG. 3B is a diagram of an example of a document being processed in accordance with an example of a document assembly method, according to some embodiments.

In another example, the assembly processor 152 is configured to separately process each of “x” and “y” as field indicators when “{x.y}” is encountered. If a field is found that matches “x”, the assembly processor 152 then determines whether a predetermined character (such as “*”) appears in the field name. If yes, the assembly processor 152 interprets “x” as the associated item of the matching field. If no, the assembly processor 152 does not interpret “x” as the associated item of the matching field. The delimiters and escape characters described and used in the examples herein are merely illustrative, and any suitable delimiters, escape characters, notation or data structures may be used in accordance with the disclosed systems and techniques.

In certain implementations, the associated item of a field may include a portion of a field indicator that is used in a complete field indicator during document generation. These portions may or may not be demarcated by escape characters, and thus may serve as either content or field indicators, depending upon the context in which they are used during document assembly. An example of this functionality is described in the document assembly example of FIG. 3, with reference to the intermediate pages A 300, B 302 and C 306. A field may include multiple content items and multiple field indicators, arranged in any order. For example, the field 222 of the data page 208 (“Cover_Deal_Acmee_and_Beta”) of FIG. 2 includes a field name 225 (“Confidee”) and an associated item 227 with both content (“The”) and a field indicator (“{t2p}”).

Returning to the flow chart 100 of FIG. 1A, once a plurality of data pages has been presented to the user at the step 102, the user selects a form page and a list of data pages to be used in assembling the document. To do this, the user provides an input at the step 104 via the input device 156. The input provided at the step 104 identifies a form page selected by the user, and a list of at least some of the plurality of data pages presented at the step 102.

A form page is a data page that is selected to provide a basis for the document to be assembled. The form page can be thought of as a “framework” or “outline” which is filled in by content when the document is assembled. The form page may be distinguished from other data pages in any of a number of different ways, including by having a particular data structure (different from the data structures of the other data pages), its name (e.g., including the text string “form”), its position in a list of data pages (e.g., at the top or bottom of the list, discussed in additional detail below), or any other designation by a user and/or the assembly processor 152. The data in the form page include one or more field indicators and can also include content, as discussed above. An example of a form page is the form page 214 (“Form_NDA”) in FIG. 2, which includes both content (e.g., the text strings “This agreement is made by” and “IN WITNESS WHEREOF”) and field indicators (e.g., the field indicators “{1p.full-name}” and “{return-of-information}”).

As mentioned above, the input provided at the step 104 also includes an indication of a list of at least some of the plurality of data pages presented at the step 102. A list 206 of data page names is illustrated in FIG. 2. The system 150 presents the name of the form page 214 after this list, and arranges the list 206 and the form page name into a binder 202. As described above, in some aspects, the binder is a presentation arrangement that represents the data pages used in the assembly of a document. A binder may also correspond to a storage arrangement in the memory 158 (e.g., the data pages included in the binder may be associated with a binder entry in a database of documents generated by a document assembly system). A binder also serves as a conceptual aid for the user, who can conceptualize the process of document assembly as selecting and customizing data pages in a particular binder. In certain implementations, a binder is a data page itself, which references one or more other data pages and form pages to be used in the assembly of a document.

The user arranges the list indicated at the step 104 in an order indicative of the user's assembly priority of such data pages. The assembly processor 152 uses the ordering of the list of data pages to match field indicators and include content in the document during document assembly. In particular, when a field indicator matches multiple field names of the data pages in the list, the assembly processor 152 preferentially uses the fields of “higher priority” data pages to replace the field indicators with content. Exemplary implementations of this processing approach are presented below and discussed with reference to FIG. 3.

After the user identifies a form page and creates a priority-ordered list of data pages at the step 104, processing of the form page data begins, in order to create the desired document. The steps 106-124 of the flow diagram 100 illustrate a processing method, which will now be discussed in detail. At the step 106, the assembly processor 152 sets a processing index to indicate the beginning of the data included in the form page. The processing index is any type of counter or pointer variable used by the assembly processor 152 to keep track of the progress of document generation, for example, by indicating which parts of the page are currently being processed. Although FIG. 1A illustrates a particular processing sequence (i.e., processing the data in the form page substantially linearly from beginning to end), processing of the form page data may be programmed to occur in any order. In certain implementations, the assembly processor 152 processes the form page data by repeatedly returning to the beginning of the form page data, identifying the next unprocessed field indicator, and processing that field indicator before returning to the beginning of the form page data again. For any processing order, the assembly processor 152 may use the processing index to identify portions of data, such as field indicators or strings of content, and process these identified portions in accordance with the techniques disclosed herein. The data identified by the processing index (i.e., the portion of data indicated by the processing index and currently undergoing processing) is referred to herein as “indexed data”. During processing, the indexed data will change as the processing index is changed. In certain implementations, the indexed data is a portion of data demarcated by one or more escape or delimiter characters. An example of such an implementation is discussed below with reference to FIG. 3.

At the step 108, the assembly processor 152 determines whether the indexed data is a field indicator. The assembly processor 152 may make this determination by recognizing predetermined escape characters, predetermined delimiter characters, a particular data structure, a formatting type, or other field indicator designations as discussed above. If the indexed data is determined to be a field indicator, the assembly processor 152 scans through the data pages in the list of data pages indicated at the step 104, in the priority order specified by the user, to find a field that matches the field indicator or a portion of the field indicator. In certain implementations, when a field indicator does not include any delimiter characters (e.g., the field indicator 207 “{2p}” of the form page 214 of FIG. 2), finding a field to match the field indicator includes finding a field name with an identical name as the text between the escape characters of the field indicator. For example, the field name 212 (“2p”) of the data page 208 (“Cover Deal Acmee and Beta”) is identical to the text between the escape characters “{” and “}” of the field indicator 207 (“{2p}”). In certain implementations, when a field indicator does include one or more delimiter characters (e.g., the field indicator 226 “{1p.full-name}”), the assembly processor 152 interprets the information provided by the delimiter characters to find a field matching the field indicator. For example, in the case of the field indicator 226 (“{1p.full-name}”) as interpreted herein, a field that matches the field indicator 226 has a field name “full-name” and may be in a data page named “1p” or in a data page with a name that is not “1p”, but is identified with the field-name “1p” by another field included in the list of data pages 206 (discussed and illustrated in additional detail below). In certain embodiments, identical matches between the field indicators and the field names are not required. Instead, a field name and a field indicator that are substantially identical or substantially similar may be considered a match, or may be flagged and presented to the user as a possible match. The criteria for “substantially identical” and “substantially similar” may be based on statistical data of past data and form pages (e.g., identifying common misspellings or typographical errors, or the popularity of different field indicators which may suggest one or more that are most likely to be intended), case folding (upper and lower case), regular expressions (in the computing sense), alternate spellings of commonly-used terms (such as “meter” and “metre”), as well as user-defined shorthand stored in the memory 158 (such as using “disc” for “disclosure”).

As discussed above, the assembly processor 152 uses priority order of the data pages in the list indicated at the step 104 to determine the order through which to scan the fields in the data pages to locate a match to the field indicator at the step 110. If no match is found in the data pages in the list, the assembly processor 152 executes a missing field indicator procedure at the step 122, examples of which are discussed in detail below, then moves the processing index to the next portion of data at the step 124. When a first match is found between the field indicator and a field, the assembly processor 152 stops scanning the data pages and continues processing at the step 114. This occurs even if another field that matches the field indicator is included later in the same data page or in a data page with a lower priority than the page in which the first match was found. In this manner, the system 150 gives “precedence” to particular fields, i.e., the data in a higher position or a higher priority data page is preferentially used during document assembly over the data in a lower priority position or data page. Thus, at the conclusion of the step 112, the assembly processor 152 has identified the highest priority data page in the ordered list of data pages that includes a field matching the field indicator (if such a data page exists).

After identifying the highest priority data page in the step 112 as just described, at the step 114, the assembly processor 152 identifies the item associated with the matching field. For example, if the indexed data at the step 108 is the field indicator 226 (“{1p.full-name}”) of the form page 214 (“Form NDA”), the assembly processor 152 scans through the data pages in the priority order represented by list 206 (i.e., starting with the data page 208 “Cover_Deal_Acmee_and_Beta”) until the first matching field name is found. In the example of FIG. 2, the first matching field 216 has the field name 204 (“1p”) of the data page 208 (“Cover_Deal_Acmee_and_Beta”). The item associated with the field 216, the text 205 (“Acmee_Vcard”) is identified at the step 114.

Once the associated item has been identified at the step 114, the assembly processor 152 inserts this identified associated item into the form page. The inserted item replaces the field indicator or a portion of the field indicator, as described in additional detail below. At the step 116, the inserted item becomes at least part of the new indexed data. The assembly processor 152 then repeats the step 108 again, this time with reference to the new indexed data. This process is illustrated below with reference to FIG. 3.

As described above, if the assembly processor 152 determines at the step 108 that the indexed data is a field indicator, the assembly processor 152 proceeds to execute the step 110. However, if the assembly processor 152 determines that the indexed data is not a field indicator at the step 108 (e.g., the indexed data is some form of content), the indexed data is output to the document at the step 118. At the step 120, the assembly processor 152 determines whether all of the form data has been processed (e.g., by determining whether the processing index has reached the end of the form data). If additional form page data remains to be processed, the assembly processor 152 moves the processing index to make a new portion of data the indexed data at the step 124, and then executes the step 108 on the new indexed data. At the step 120, if the assembly processor 152 determines that all of the form data has been processed, then the document has been assembled and is generated for presentation to the user at the step 126.

An example document assembly performed in accordance with the document assembly method of FIG. 1A is now discussed with reference to the binder 202 of FIG. 2 and illustrated in FIG. 3. As mentioned above, the binder 202 includes a list 206 of data page names, as well as a form page name. The data pages named in the list 206 each include fields, which in turn include a field name and an associated item. In certain implementations, at least one of the data pages named in the list 106 is a “case page” which customizes the document for a user-selected application. For example, the data page 212 (“Technology_Only”) is a “case page” that is included in a binder when the user is assembling a non-disclosure agreement in which the confidee is limited to using the information only to evaluate a license of the confider's technology. In certain implementations, at least one of the data pages in the list 206 is a “deal page” which provides content for the document that is particular to a specific transaction. For example, the data page 208 (“Cover_Deal_Acmee_and_Beta”) is a deal page that provides information regarding the specific parties (Acmee Commercial, Inc. and Beta Systems, LLC) engaging in a business transaction or legal agreement.

FIG. 3 illustrates the processing of an example document corresponding to the binder 202 of FIG. 2 using the document assembly method of FIG. 1A. In the embodiment illustrated in FIG. 3, the document is generated by sequentially generating a number of intermediate documents, each including additional refinements over the last, with the processing concluding with a final assembled document. At the beginning of processing (the step 106 of FIG. 1A), the first intermediate document A 300 (FIG. 3A) includes exactly the data of the form page 214 (“Form_NDA”) of the binder 202 of FIG. 2. As the assembly processor 152 processes the data in the intermediate page A 300, the content in the data is preserved in the intermediate document A 300 (the steps 118 and 124 of FIG. 1A) until the first field indicator 301 (“{1p.full-name}”) is identified (the determination “YES” at the step 308 of FIG. 1A). The assembly processor 152 then executes the step 110 of FIG. 1A, scanning through the data pages in the list 206 according to the priority order until a matching field 216 (with the field name 204 “1p” in the data page 208 “Cover_Deal_Acmee_and_Beta”) is found (the determination “YES” at the step 312 of FIG. 1A). The item 205 (“Acmee_Vcard”) associated with the field 216 is identified (the step 114 of FIG. 1A), and the item 205 is inserted into the document as an insert 303 in the intermediate document B 302 (the step 116 of FIG. 1A).

Once the insert 303 has been included in the intermediate document B 302, the assembly processor 152 uses the processing index to identify the next field indicator 304 (“Acmee_Vcard.full-name”). In other words, the field indicator 301 (“{1p.full-name}”) of the form 214 (“Form_NDA”) is “replaced” during processing by the field indicator 304 (“{Acmee_Vcardfull-name}”) because of the field 216 (“1p=Acmee_Vcard”) in the data page 208 (“Cover_Deal_Acmee_and_Beta”). To process the field indicator 304, the assembly processor 152 scans through the data pages in the list 206 according to the priority order until a matching field 203 (the field name “full-name” in the data page 210 “Acmee_Vcard”) is found. The item 211 (“Acmee Commercial, Inc.”) associated with the field 203 is identified, and the item 211 is inserted into the document as an insert 308 in the intermediate document C 306.

The assembly processor 152 continues to move the processing index through the data of intermediate document C 306, preserving the content in the data until the next field indicator 310 (“{2p}”) is identified. The data pages of the list 206 are again scanned according to their priority order until a matching field 220 (with the field name 212 “2p” in the data page 208) is found. The item 213 (“Beta Systems, LLC”) associated with the field 220 is identified, and the item 213 is inserted into the document as an insert 314 in the intermediate document D 312.

The assembly processor 152 continues to move the processing index through the data of intermediate document D 312, preserving the content in the data until the next field indicator 316 (“{Sec_Use_Of_Information}”) is identified. The data pages of the list 206 are again scanned according to their priority order until a matching field 228 (with the field name 221 “Sec_Use_Of_Information”) is found. The item 223 (“{Technology_Only.use_for_evaluation}”) associated with the field 228 is identified, and the item 223 is inserted into the document as an insert 320 in the intermediate document E 318. The item 223 (and consequently the insert 320) includes a field indicator, so the assembly processor 152 then processes the insert 320 in accordance with the flow diagram 100 of FIG. 1A. The data pages of the list 206 are scanned according to their priority order until a matching field 217 (with the field name “use-for-evaluation” in page 212 “Technology_Only”) is found. The item 219 (“{Confidee} will use the information only to evaluate a possible license of technology}”) associated with the field 217 is identified, and the item 219 is inserted into the document as an insert 324 in the intermediate document F 322.

As occurred in the processing of the intermediate document E 318, the insert 324 in the intermediate document F 322 includes a field indicator 326, so the assembly processor 152 then processes the field indicator 326 included in the insert 324 in accordance with the flow diagram 100 of FIG. 1A. The data pages of the list 206 are scanned according to their priority order until a matching field 222 (with the field name 225 “Confidee”) is found. The item 227 (“The {t2p}”) associated with the field 222 is identified, and the item 227 is inserted into the document as an insert 330 in the intermediate document G 328.

Since the insert 330 in the intermediate document G 328 includes a field indicator 332 (“{t2p}”), the assembly processor 152 processes this field indicator 332. The data pages of the list 206 are scanned according to their priority order until a matching field 229 (with the field name “t2p”) is found. The item 230 (“Receiving Party”) associated with the field 229 is identified, and the item 230 is inserted into the document as an insert 336 in the intermediate document H 334 (FIG. 3B).

The assembly processor 152 continues to move the processing index through the data of the intermediate document H 334, preserving the content in the data until the next field indicator 338 (“{return-of-information}”) is identified. The data pages of the list 206 are scanned according to their priority order until a matching field 234 (with the field name “return-of-information” in the data page 212 “Technology_Only”) is found. The item 235 (“All information shall be returned within {time-to-return}”) associated with the field 234 is identified, and the item 235 is inserted into the document as an insert 342 in the intermediate document I 340.

Since the insert 342 in the intermediate document I 340 includes a field indicator 344 (“{time-to-return}”), the assembly processor 152 processes this field indicator 344. The data pages of the list 206 are scanned according to their priority order until a matching field 231 (with the field name “time-to-return” in the data page 208 “Cover_Deal_Acmee_and_Beta”) is found. Observe that another field 232 (of the data page 212 “Technology Only”) also includes a field name 233 matching the field indicator 344 (“{time-to-return}”). However, since the data page 208 has a higher priority than the data page 212, the field 231 is considered the correct match to the field indicator 344. The item 237 (“thirty days from the receipt of notice by certified letter”) associated with the field 231 is identified, and the item 237 is inserted into the document as an insert 348 in the intermediate document J 346.

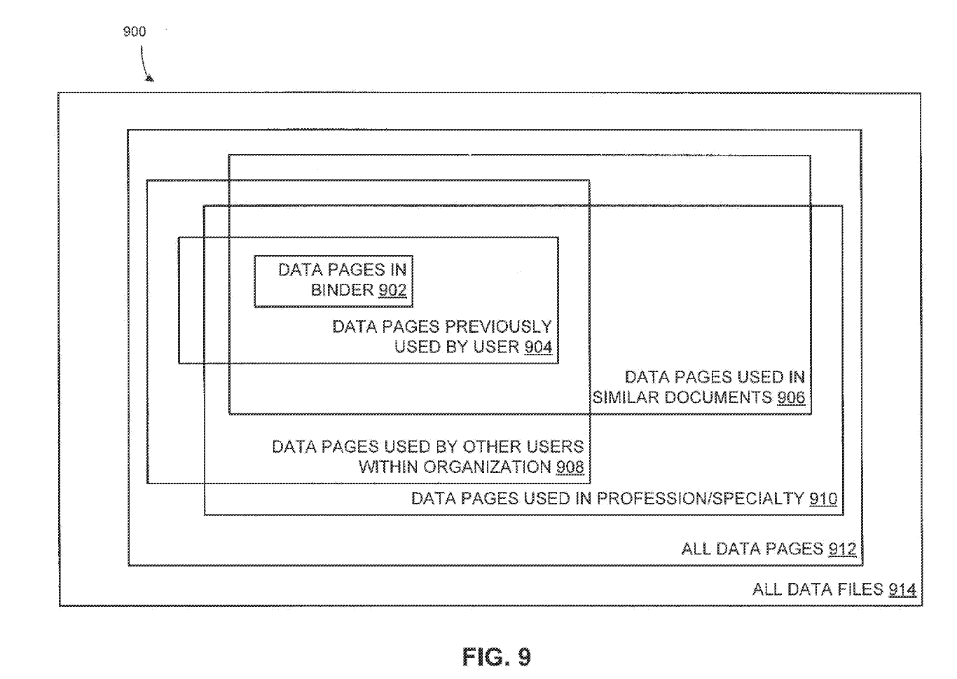

The assembly processor 152 continues to move the processing index through the data of the intermediate document J 346, preserving the content in the data until the next field indicator 350 (“{Sec_NDA_Confidentiality_Engagement}”) is found. The data pages of the list 206 are scanned according to their priority order, but there is no field name in any of the data pages of the list 206 that matches the field indicator 350 (a determination of “NO” at the step 112 of FIG. 1A). As described above, the assembly processor 152 then executes a missing field indicator procedure at the step 122. In certain implementations, the missing field indicator procedure includes determining whether any data page, in the plurality of data pages from which the list of data pages (e.g., the list 206 of FIG. 2) was drawn, has a page name matching the field indicator. If such a data page can be found, then the assembly processor 152 will treat that data page as a matching field, with the name of that data page as the field name and the data in that data page as the item associated with the field for the purposes of the flow diagram 100 of FIG. 1A. Such an implementation is illustrated in FIG. 3. Because no field name in any of the data pages of the list 206 matches the field indicator 350 (“{Sec_NDA_Confidentiality_Agreement}”), the assembly processor 152 searches all of the data pages in its memory 158 and finds the data page 230 of FIG. 2. The data of the data page 230 is inserted into the document as an insert 360 in the intermediate document K 352. It will be noted that data page 230 does not contain any fields or indicators, only content, but it may contain any combination of fields, field indicators and content. Different ways in which the assembly processor 152 may search the data pages (and data files more generally) in the memory 150, are discussed below with reference to FIG. 9.

Other missing field indicator procedures may be implemented at the step 122, in addition to or instead of the procedure just described. For example, when no data page in the ordered list of data pages includes a field matching the field indicator, the assembly processor 152 may output a marker to the document, such as “MISSING INDICATOR” highlighted in a boldfaced, colored font. The marker can include information about the missing field indicator, and can alert a user to this condition so that the user can return to the binder and correct the error. In certain implementations, the missing field indicator procedure includes creating a new field in the highest priority data page with the missing field name and no associated item (e.g., an empty string), which the user may provide with the desired item. In certain implementations, the assembly processor 152 presents a suggested field indicator to the user, based on similar or similarly-used field indicators in other data pages and form pages in the binder being assembled, or other binders available to the system 150.

Returning to the intermediate document K 352 of FIG. 3, the assembly processor 152 continues to move the processing index through the data of the intermediate document K 352, preserving the content in the data until the next field indicator 356 (“{additional-provisions}”) is found. The data pages of the list 206 are scanned according to their priority order until a matching field 224 (“additional-provisions”) is found. However, the item 234 associated with the field 224 is an empty string. In certain embodiments, the assembly processor 152 treats an empty string item as intentionally omitted and deletes the document list item 357 (“4.”) from the intermediate document K 352 to create the next document 358.

The assembly processor 152 continues to move the processing index through the data of the document 358, preserving the content in the data until the next field indicator is found. However, there are no remaining field indicators in the document. Once the processing index has been moved through all of the content of the document 358, the end of the data is reached (a determination of “YES” at the step 120 of FIG. 1A) and the resulting document 358 may be generated and presented to the user (the step 124 of FIG. 1A). The generated document may be displayed, saved, e-mailed, printed, faxed, posted to a web site, or transmitted or presented to a user via the presentation device 154, the network 160, or any other mechanism.

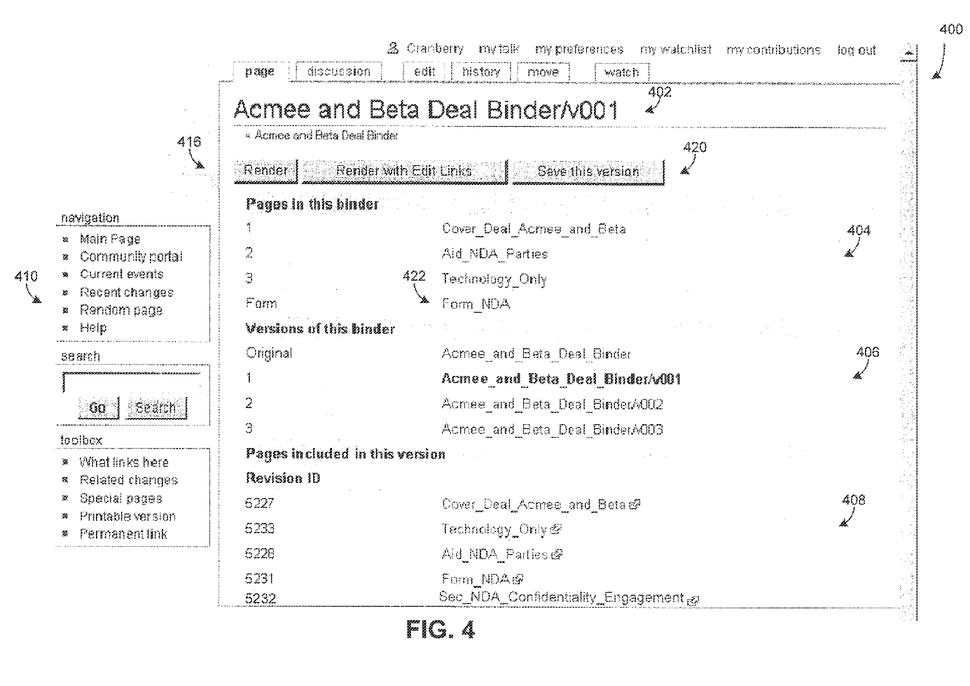

The document assembly method of FIG. 1A may be presented to a user by the assembly processor 152 via a user interface on the presentation device 154. FIG. 4 is a diagram of an example of a user interface display 400 in accordance with an example of a document assembly method, according to some embodiments. The user interface display 400 can be used with the method of FIG. 1A to present the generated document and information regarding at least some of the data pages in the binder. As illustrated, in certain implementations, the plurality of data pages presented to the user at the step 102 of FIG. 1A are presented to the user by a wiki application executed by a server, such as a web or intranet server. In some such implementations, the processing of the data in the form page (i.e., the steps 108-124 of FIG. 1A) is performed by the server. In particular, the display 400 represents the contents of a binder with a title 402 (“Acmee and Beta Deal Binder/v001”). The display 400 includes three sections: the section 404 (“Pages in this binder”), the section 406 (“Versions of this binder”), and the section 408 (“Pages included in this version”). A functions region 410 of the display 400 includes navigation functions, search functions and additional functions, as are known in the art. In some implementations, a category section (not shown) indicates categories into which the data pages listed in the binder (e.g., in the section 404) may belong, or other categories related to the binder (such as business or practice specialty categories). The render button 416 allows a user to initiate the generation of a document according to the method of the flow diagram 100 of FIG. 1A, which creates the document defined by the binder represented in the display 400. The section 404 includes an ordered list of data pages, as well as a form page title 422. A user may select any of the pages included in the binder to view the contents of that page (e.g., by using a cursor or touch pad to indicate a page).

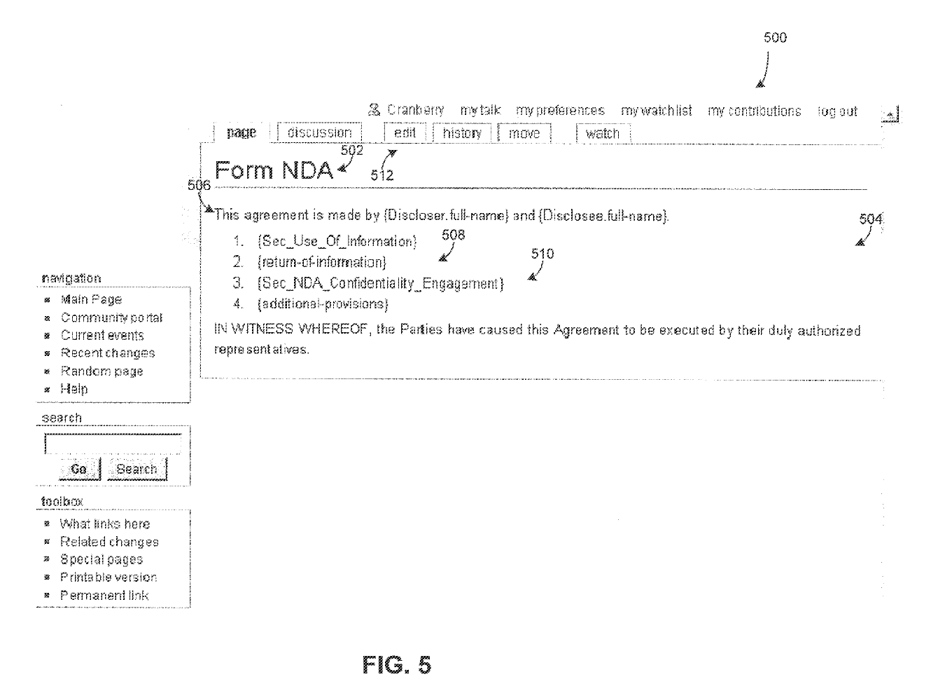

In certain implementations, in response to receiving a user selection of the form page title 422, a display 500 of FIG. 5 is presented to the user via the presentation device 154. FIG. 5 is a diagram of an example of a user interface display 500 in accordance with an example of a document assembly method, according to some embodiments. The display 500 includes the form page title 502 and the form data 504 included in the form page. The data 504 includes text content, such as the text content 506, as well as field indicators such as the field indicator 508 and the field indicator 510.

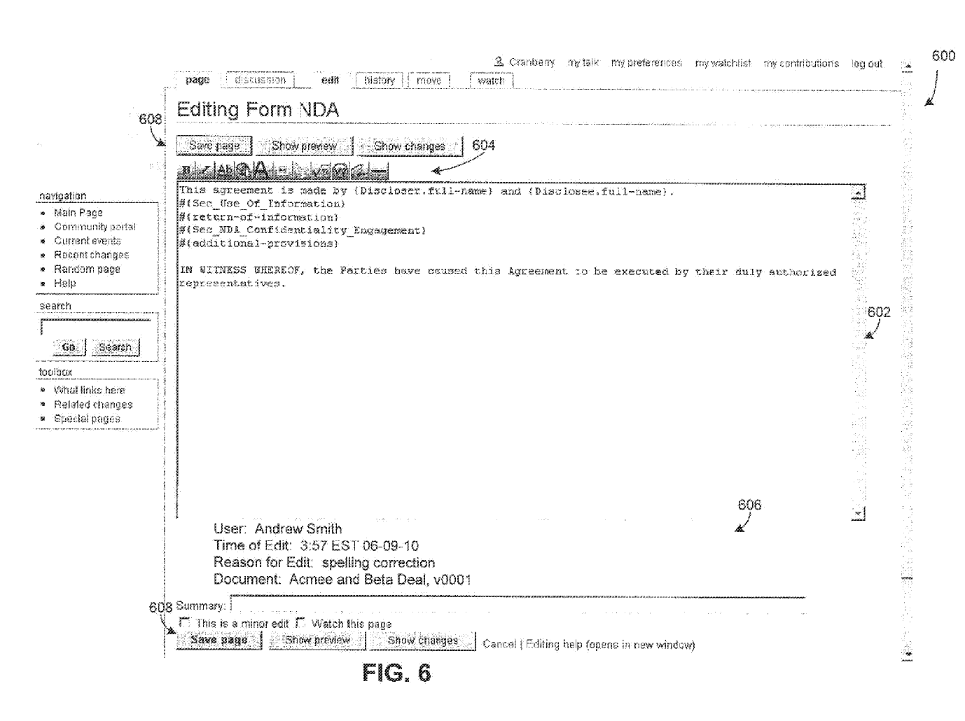

In response to the user selecting the edit tab 512 at the top of the display 500, the presentation device 154 presents the display 600 of FIG. 6. FIG. 6 is a diagram of an example of a user interface display 600 in accordance with an example of a document assembly method, according to some embodiments. The display 600 includes a text field 602 in which the form page data may be edited by the user via the input device 156 (e.g., a keyboard or touch pad). Additional word processing function buttons 604 are also included in the display 600, allowing the user to perform known word processing functions on the text within the text field 602. In certain implementations, form pages and data pages are HTML or other mark-up language documents that can be actively edited by a user in a word processing application (e.g., a simple text editor for RTF or XML documents, or a more full-featured application such as Microsoft Word or OpenOffice) installed on a user's local device (e.g., desktop, laptop or handheld device), while the remainder of the document assembly process is performed by an assembly processor 152 located on a remote server. In certain implementations, the assembly processor 152 recognizes an input from the input device 156 including an indication of at least one edit to at least one data page in an ordered list (e.g., the ordered list of data pages in the section 404 of the display 400 of FIG. 4), and in response, the assembly processor 152 updates the at least one data page with the at least one edit, prior to processing the data in the form page. In some such implementations, at least one data page is presented to the user in a plain text or HTML format in a text editor. A change made by the user to the plain text or HTML in the text editor can be flagged or annotated to indicate an edit made to the data page. In certain implementations, when a user edits a field in a data page in the binder, the assembly processor 152 records the edit as a new, modified field with the same field name in the highest priority page, or some lower priority page selected by the user. In certain implementations, the assembly processor 152 receives a user input to change a priority of one or more fields, and in response, “pushes” the one or more fields “down” the priority list within the same data page or into another data page that the user regards as appropriate (e.g., by rearranging the data pages and/or fields in the memory 158). Similarly, the assembly processor 152 may push one or more fields “up” the priority list within the same data page or into a higher priority data page in response to a user input. Additionally, the assembly processor 152 may push one or more data pages “up” or “down” in the priority list in response to a user input.

The display 600 of FIG. 6 includes an annotation region 606. An annotation region may indicate metadata associated with a binder, a data page, a form page, or an edit thereof. For example, the annotation region 606 indicates the identity of the user, a time of the edit, the binder in connection with which the edit was made, and a reason for the edit. The metadata in an annotation region may be automatically included by the assembly processor 152 (e.g., the time of an edit), manually included by a user (e.g., a reason for the edit), or a combination of the two.

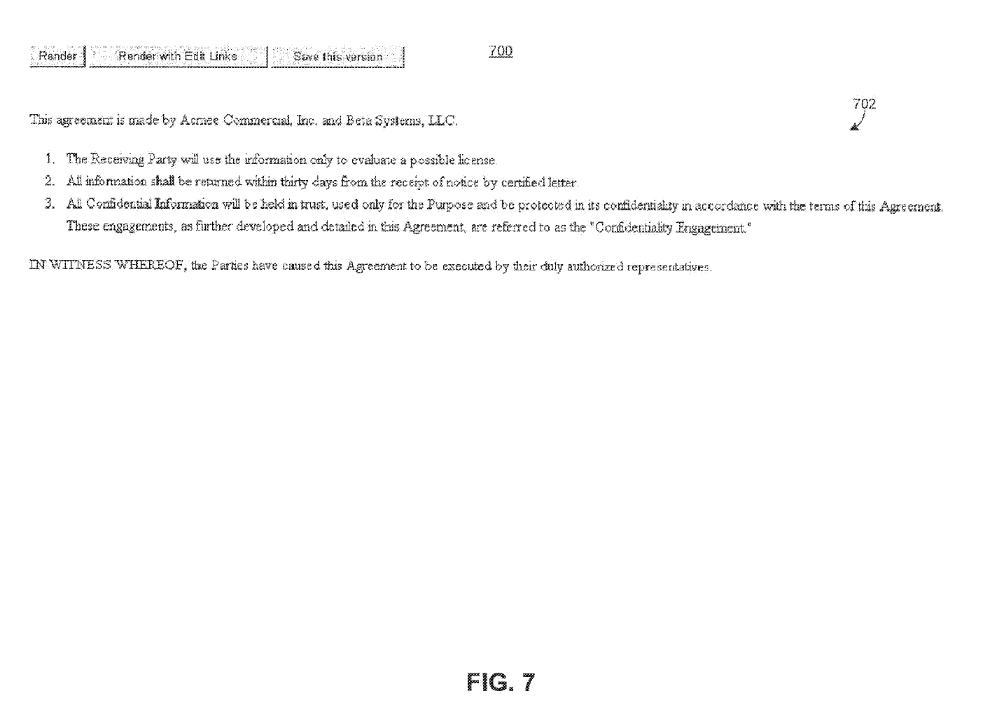

When the user selects the save page button 608, a display (similar to the display 500 of FIG. 5) is presented, reflecting the edits made by the user. When the user returns to the display 400 of FIG. 4, and selects the render button 416, the display 700 of FIG. 7 is presented. FIG. 7 is a diagram of an example of a user interface display in accordance with an example of a document assembly method, according to some embodiments.

The display 700 may include the generated document 702 as assembled by the assembly processor 152 in accordance with the document assembly method illustrated in FIG. 1A. In certain implementations, a user is given the option to select between a number of different presentation formats of the generated document. Examples of different presentation formats include a final document, a draft document in which there is special formatting around the parts of the text that correspond to recent edits or that were included in different data pages in the binder (e.g., the data pages and fields <a href=“Acmee Vcard#full-name”> identified during the processing of the data in the form page), and a “linked” document that allows a user to select a portion of the generated document to navigate directly to the data page and field that supplied the selected portion (e.g., through href navigation in an HTML document), or to “mouse-over” or select a field, in response to which a text edit function is presented to the user for editing the selected field.

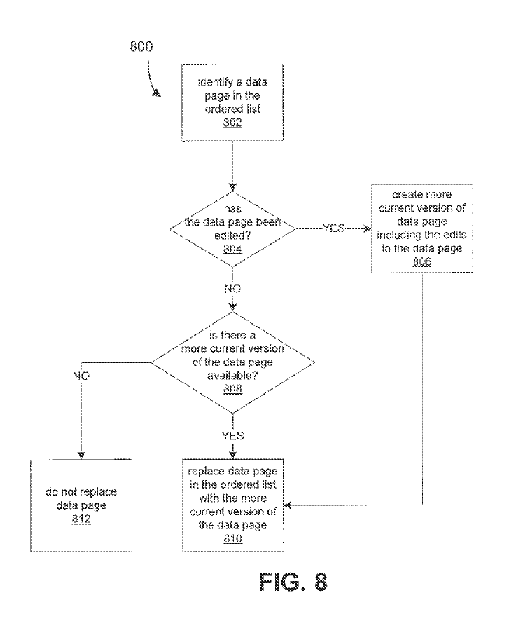

In certain implementations, the document assembly systems and techniques disclosed herein include versioning systems and techniques. Some such implementations prevent a data page from being edited when other binders include that data page, thus preventing breaks in the integrity of the documents generated from these other binders. Instead, new versions of a data page are created that include the edits. FIG. 8 is a diagram 800 of an example of a method for versioning generated pages, such as data pages, according to some embodiments. The versioning method depicted in FIG. 8 can be used to maintain and update different versions of data pages. At the step 802, the assembly processor 152 identifies a data page in the ordered list of data pages (i.e., the list received from the user at the step 104 of the flow diagram 100 of FIG. 1A). This identification may arise from a user selection of a data page using the input device 156, or may be made by the assembly processor 152 as part of an automatic version check of the data pages prior to document assembly. At the step 804, the assembly processor 152 determines whether the identified data page has been edited or otherwise changed by the user or another entity. If the identified data page has been edited, the assembly processor 152 creates a more current version of the data page, with the more current version including the edits to the data page. The assembly processor 152 then replaces the identified data page in the ordered list of data pages (e.g., by changing a pointer in memory) so that when the user generates a document using the ordered list, the document will reflect the edits.

At the step 804, if the identified data page has not been edited, the assembly processor 152 determines whether a more current version of the data page is available at the step 808. This may occur, for example, when the legal department of a corporation uploads an updated set of boilerplate clause data pages to the document assembly system 150, with similar or different titles to associated existing boilerplate clause data pages and with new or revised content. If the assembly processor 152 identifies that a more current version of the data page is available at the step 808, the assembly processor 152 executes the step 810 as described above, replacing the data page in the ordered list with the more current version. If the assembly processor 152 does not identify a more current version of the data page at the step 808, the assembly processor 152 does not replace the data page in the ordered list (the step 812). In certain implementations, the versioning method illustrated in FIG. 8 is performed by the assembly processor 152 prior to processing the data in the form page in accordance with the flow diagram 100 of FIG. 1A. In certain implementations, the versioning method illustrated in FIG. 8 includes one or more notifications or requests for permission from one or more users or administrators of the system 150. For example, the assembly processor 152, upon creating or detecting a new version of a data page, may take one or more actions including notifying the user, requesting permission of the user before replacing the data page in the ordered list with the more current version, and notifying one or more past users of the data page.

Several techniques are described herein in which the assembly processor 152 searches a collection of data pages or other data files to identify pages matching certain criteria. When searching a collection of data, the assembly processor 152 may execute the search by examining different collections according to a search priority. FIG. 9 is a Venn diagram 900 showing examples of relationships of different collections of data files, according to some embodiments. Different collections of data files may include the data files stored in the memory 158 of the document assembly system 150, or accessible to the document assembly system 150 via the connection to the network 160. The collection 902 represents pages included in a particular binder. The collection 904 represents pages that have been previously used by the user in a binder (and may include pages that have been “favorited,” authored, or otherwise collected or identified by a user as being relevant or valuable). The collection 906 represents pages that have been used in documents similar to the document defined by the particular binder (e.g., as determined by the assembly processor 152 using an analysis of data pages that are commonly used together in different binders, pattern matching or natural language processing algorithms on the content or metadata of the binders, or as determined by the votes or ratings of users of the document assembly system 150). The collection 908 includes pages used by other users within the particular user's organization (e.g., colleagues, business associates). The collection 910 includes pages used in the profession or specialty of the user (e.g., licensing agreements, property agreements, purchase orders, warranties). The collection 912 includes all data pages available to users of the document assembly system 150 and the collection 914 includes all data files available to users (which may include sources such as websites, reviews, encyclopedia entries, any Internet or bulletin board content, etc.). A user (or administrators in a user's organization) may program the search priority among these collections (and/or other collections) into the assembly processor 152, which the assembly processor 152 then follows during document assembly, if collections of non-binder materials are to be searched.

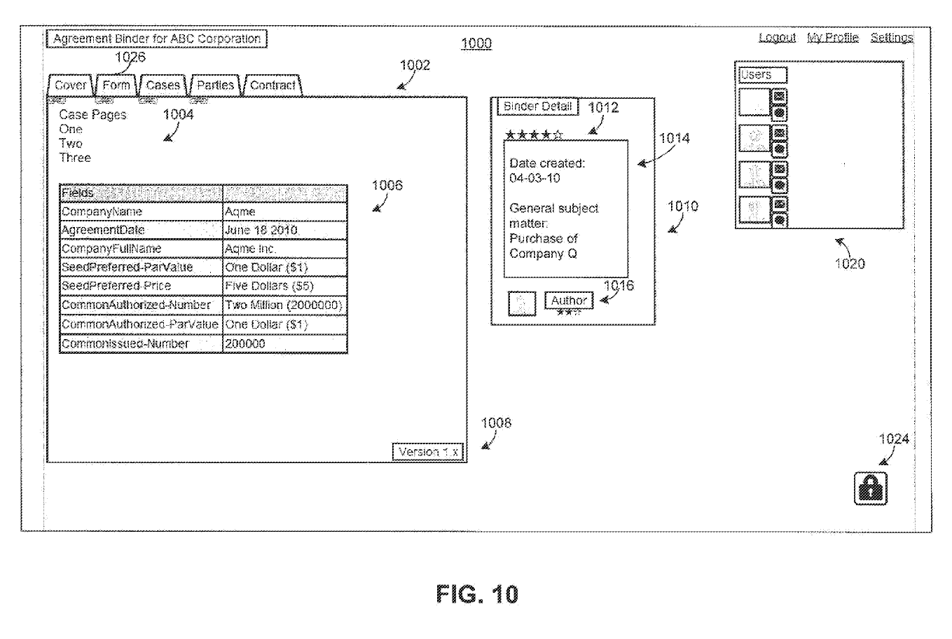

FIG. 10 is a diagram of an example of a user interface display 1000 in accordance with an example of a document assembly method, according to some embodiments. The user interface display 1000 that can be used with the document assembly techniques disclosed herein. The display 1000 includes a data page region 1002 which includes a list of case pages 1004 as well as a set of fields 1006. The display 1000 also includes a binder detail region 1010 which provides information regarding the binder, including a rating 1012 (e.g., as provided by different users of the document assembly system 150), a description region 1014 including the binder's date of creation and general subject matter, and an author region 1016 for identifying and describing the author of the binder. The display 1000 further includes a users region 1020 which provides descriptions of other users of the document assembly system 150 (and may be limited to other users authorized to view or edit the document associated with the binder). In certain implementations, user comments regarding the data pages or form page included in the binder are presented in at least one of the binder detail region 1010 and the users region 1020. These user comments may aid the user in selecting and editing data and form pages for inclusion in the binder.

The display 1000 also includes a lock button 1024. In certain implementations, when a user selects the lock button 1024, the assembly processor 152 ensures that when a document is generated from the binder, the form and data pages used during assembly are the form and data pages current when the lock button 1024 was selected (i.e., no subsequent revisions or updates are included). Locking may also apply to any other data pages used during document assembly, including those not listed as being part of the binder (e.g., those taken from a database of data pages during document assembly). The versioning may be done by a data page naming system such as Sec_Law_v001, Sec_Law_v002, etc. The “lock” function may be performed by creating a new high priority data page that includes the field “Sec_Law=Sec_Law_v003” (or adding such a field to an existing high priority data page). In this embodiment, when the field indicator “{Sec_Law}” appears, the data page “Sec_Law_v003” is used to provide associated items (instead of a newer or different version of the “Sec_Law” data page).

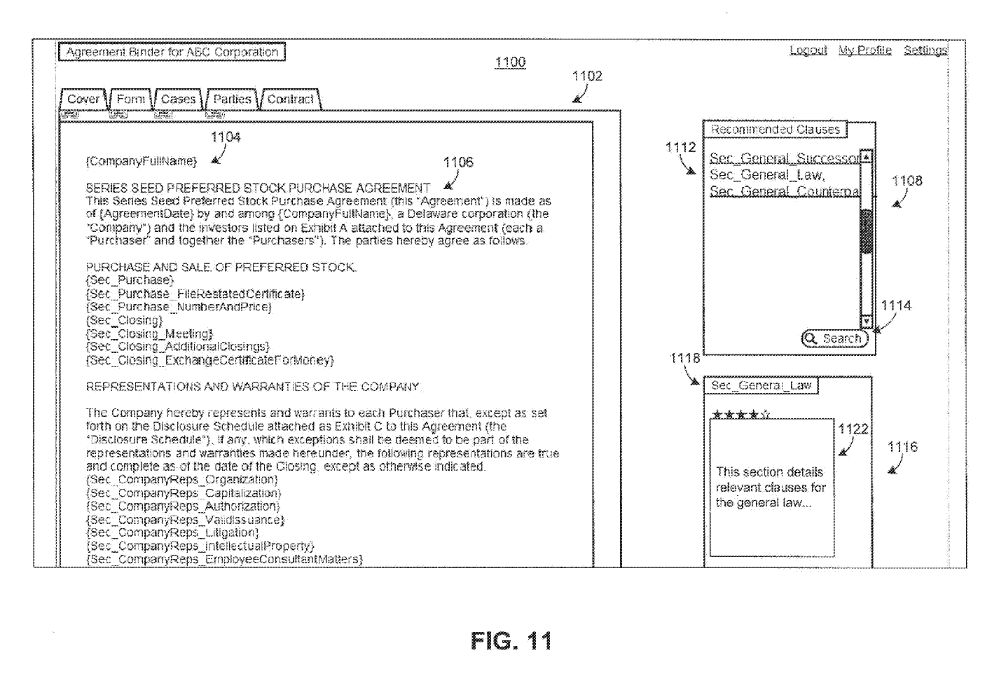

When a user selects the tab 1026 of the display 1000, the display 1100 of FIG. 11 is presented. FIG. 11 is a diagram of an example of a user interface display 1100 in accordance with an example of a document assembly method, according to some embodiments. The display 1100 includes a form data region 1102 in which the form data is presented. The form data presented in the form data region 1102 includes both field indicators such as the field indicator 1104 and text content such as the text content 1106. The display 1100 also includes a recommended clauses region 1108 which provides a list of recommended clauses to the user. When a user selects a recommended clause such as the recommended clause 1112 from the recommended clauses region 1108, a description of the selected clause is presented in the clause description region 1116. In FIG. 11, the clause description region 1116 includes the clause title 1118, a rating of the clause 1120 and a clause description 1122. The recommended clauses region 1108 also includes a search button 1114 which a user may select to search the available clauses.

The assembly processor 152 may present clause recommendations to a user based on an analysis of data pages that are commonly used together in different binders, pattern matching or natural language processing algorithms on the content or metadata of the binder, as determined by the votes or ratings of users of the document assembly system 150. In these implementations, a recommendation for a user input is presented to a user based at least in part on some of the content of the binder (i.e., the ordered list of data pages and the form page). In certain implementations, the assembly processor 152 analyzes the data in one of the data pages or the data in the form page and detects a similarity to an existing data or form page. The assembly processor 152 then recommends that the user consider this existing data or form page. The assembly processor 152 may also indicate other users who have created similar documents.

The recommended clauses region 1108 may include or be replaced with a document advisor region, which provides a user with information to guide the user through the creation of a document. In certain implementations, the document advisor takes the form of a series of queries regarding document content and the user's preferences for data and form pages. This series of queries can be thought of as a document assembly “decision tree,” in which the user's responses determine which data and form pages are included in the document, as well as the next query to be presented. The queries may be based on binders previously created by the user and/or decisions made by other users of the system 150. For example, when a user indicates that a contract should include an intellectual property provision, the assembly processor 152 may present one or more of the most popular intellectual property provision data pages in its memory 150 (as determined by use or rating), and allow the user to select which provisions to include.

A user or a user's organization may customize the document assembly system 150 with approved or recommended data pages and form pages to ensure that generated documents comply with organization policies. In certain embodiments, a user or a user's organization may provide an indication of document assembly requirements to the assembly processor 152, prior to processing the data in the form page. These document assembly requirements may include one or more data or form pages that must be included in the ordered list in a binder, guidelines for the user on data that is allowed to be included in at least one of the plurality of data pages, or any combination thereof.

For example, a company's legal department can create a data page including the following data fields:

Sec_Law = {AqmeLegalDept_Sec_Law}
Sec_Forum = {CmAccGen_Forum_v39}

By including this data page in a binder with a high priority, any document generated using this binder will first look to this data page for content to replace field indicators in the form page, and thus will preferentially include the content approved by the legal department. In such embodiments, a user may include a data page with their preferred content with even higher priority than the legal department data page. In certain implementations, the document assembly system 150 can be configured by to limit the data pages that can be included in a binder, and/or the order in which data pages are included (e.g., by setting binder requirements within the programming of the assembly processor 152).

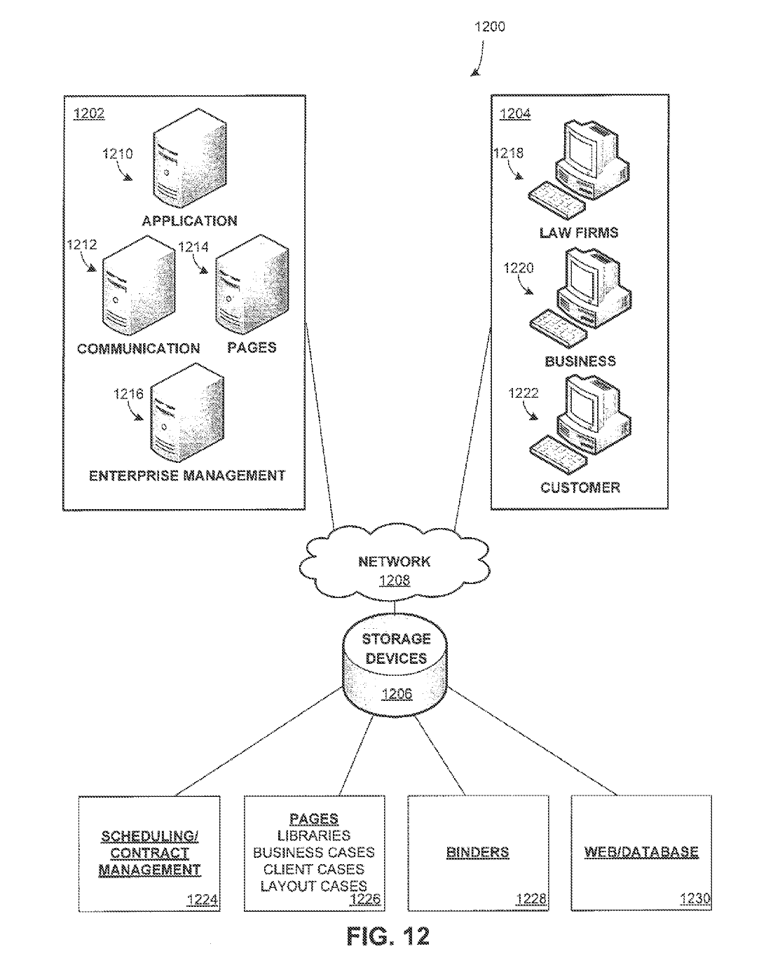

In certain embodiments, the document assembly system 150 may be implemented over a network of devices, with different tasks distributed over one or more devices in the network. FIG. 12 is a diagram of an example of a network system 1200 configured to serve a document assembly system, according to some embodiments.

FIG. 12 depicts a network-based system 1200 configured to serve as the document assembly system 150 and perform the document assembly techniques described herein. The system 1200 includes the server devices 1202, the client devices 1204, a network 1208 and the storage devices 1206. The server devices 1202 include an application server 1210, a communication server 1212, a pages server 1214 and an enterprise management server 1216. The operations of the assembly processor 152 may be distributed over one of more these server devices, and the server devices may also provide the functions customarily provided by such server devices (e.g., the enterprise management server 1216 may provide enterprise management applications and services along with the document assembly techniques described herein). The client devices 1204 include law firm client devices 1218, business client devices 1220 and customer client devices 1222. These client devices may include presentation devices (such as the presentation device 154) and input devices (such as the input device 156). The storage devices 1206 include data stores such as related scheduling/contract management store 1224, data pages store 1226, binder store 1228 and web/database store 1230. The document assembly system 150 may reside at any location (e.g., client or server) accessible to the network, as may the data pages and binder information. In certain implementations, different intranet-based servers provided by different organizations (e.g., different companies and law firms) and operating behind different firewalls, draw data from and contribute data to a public server. In such implementations, the public server may act as one or more of a central repository, processing entity and contact point for a network-based implementation of the system 150.

In certain embodiments, the document assembly techniques described herein provide distributed editing capability to multiple users at different client devices connected to a network. In such an embodiment of the document assembly system 150, a plurality of users have access to and editing rights over binders, data pages and form pages. Versioning may be used to avoid conflicts between different users. Additionally, different data pages and portions of the form page may be assigned to different users based on their expertise or access rights. For example, the IP sections of an agreement binder may be assigned and accessible to an IP lawyer, while a data page including the description of a physical installation may be assigned and accessible to the engineer. In some such implementations, different users are given access to different pages in a “deal locker,” and may work independently. These pages are then included in a binder and become part of the generated document.

In some embodiments, binders provide a map of relationships, transactions and histories, both in the organization and with others with whom it has relations; internal transactions may be understood as one entity (e.g., individual, division, department, function) interacting with another member of the organization.

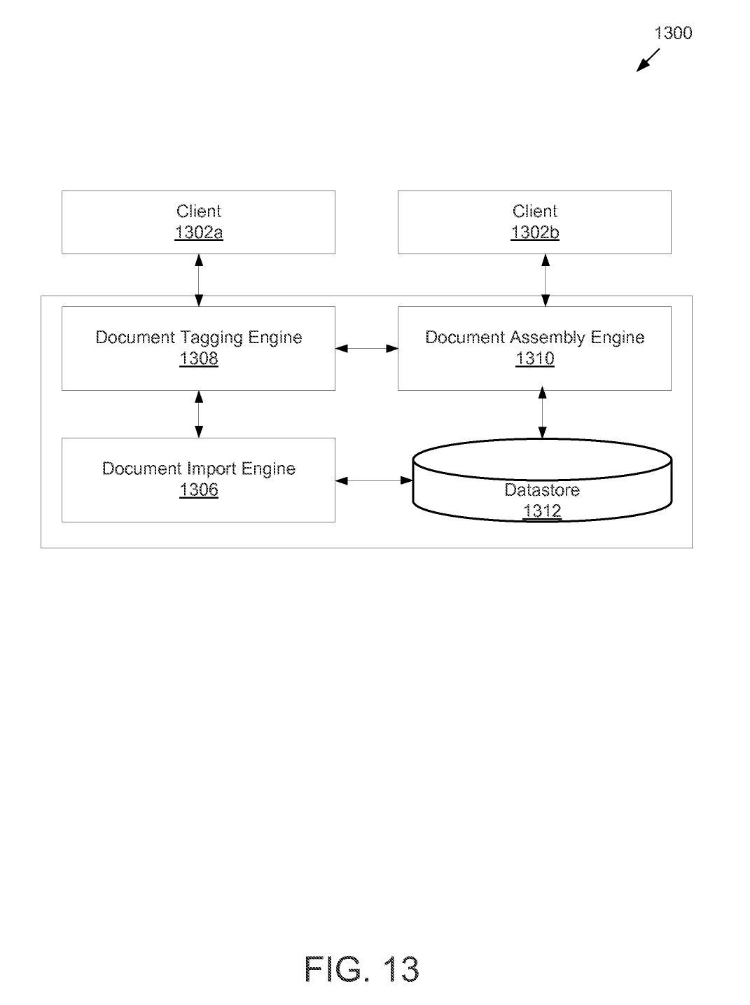

The methods and systems described herein include functionality for identifying a standard document component in a community and automatically generating a document containing the standard document component. Referring now to FIG. 13, a block diagram depicts one embodiment of a system for identifying a standard document component in a community and automatically generating a document containing the standard document component. FIG. 13 is a diagram of an example of a system 1300 for identifying a standard document component in a community and automatically generating a document containing the standard document component, according to some embodiments.

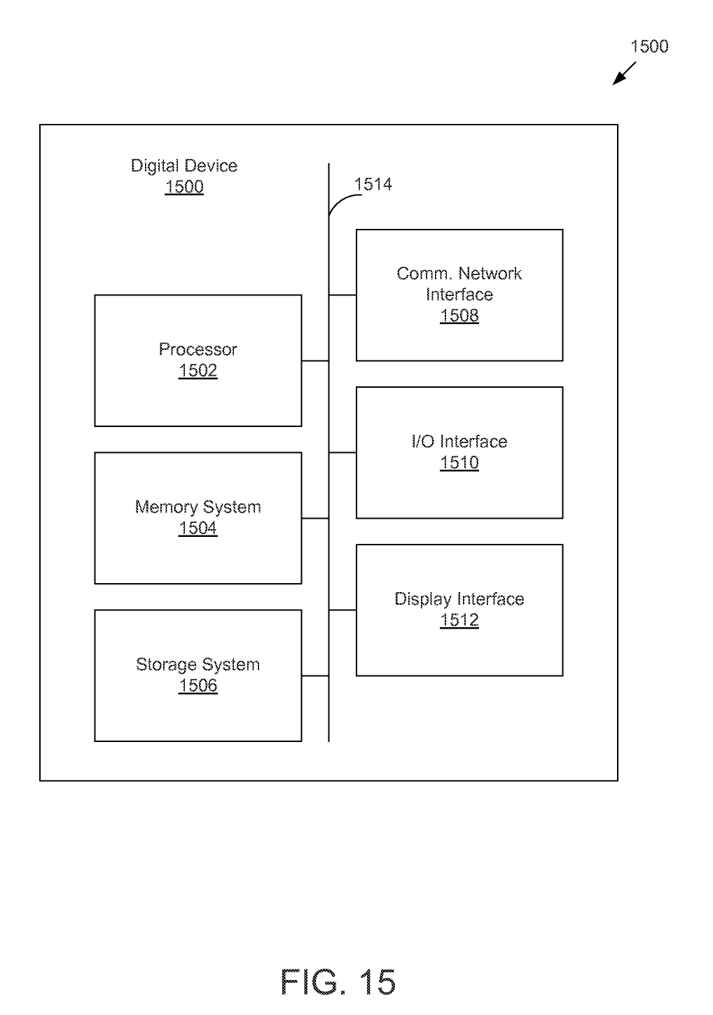

The system 1300 may include a first client 1302a, a second client 1302b, a remote machine 1304, a document import engine 1306, a document tagging engine 1308, and a document assembly engine 1310. One or more of the first client 1302a, the second client 1302b and the remote machine 1304 may be a digital device (e.g., a digital device 1500, as shown in FIG. 15). As used herein, an “engine” is a combination of hardware and/or software and may execute one or more processes on a processor. An “engine” may also be capable of storing data on a memory.

The document import engine 1306, the document tagging engine 1308, and the document assembly engine 1310 may each execute on the remote machine 1304. The document import engine 1306 imports a first document, identifies at least one document component within the first document, and generates a data structure including a node containing the at least one document component. The document tagging engine 1308 receives, from a first member of a community, via the client 1302a, an annotation of the at least one document component and associates, with the node, metadata including the identification. The document assembly engine 1310 receives, from a second member of the community, via the client 1302b, a request to generate a second document containing a component associated with the annotation component and generates the second document containing the at least one document component.

Referring to FIG. 13, and in greater detail, the document import engine 1306 imports a first document. In one embodiment, a member of the community transmits the first document to the remote machine 1304 for processing and importing by the document import 1306.

In some embodiments, the system includes a database in which the document import engine 1306 stores the imported first document. In another embodiment, unique identifiers are assigned to items stored in the database. In one of these embodiments, the database stores data in an ODBC-compliant database. For example, the database may be provided as an ORACLE database, manufactured by Oracle Corporation of Redwood Shores, Calif. In another of these embodiments, the database can be a Microsoft ACCESS database or a Microsoft SQL server database, manufactured by Microsoft Corporation of Redmond, Wash. In still another of these embodiments, the database may be a custom-designed database based on an open source database such as the MYSQL family of freely-available database products distributed by MySQL AB Corporation of Uppsala, Sweden, and Cupertino, Calif. In further embodiments, the database may be a non-relational, document-oriented database such as a database based upon the CouchDB project distributed by The Apache Software Foundation.

In one embodiment, the document import engine 1306 generates a list, which may include sub-lists or references to other lists. In another embodiment, the document import engine 1306 generates a tree, linked list, graph, or array. In still another embodiment, the document import engine 1306 generates a flat data structure, or single-layer data structure. For example, the flat data structure (which may be referred to as a flat name space) includes unique names and a hash function may be executed to generate a hash that produces a name for later access. In yet another embodiment, the document import engine 1306 generates a hierarchical data structure such as a multi-layered tree. In still another embodiment, one of ordinary skill in the art will recognize that any number of data structures may be generated.

In one embodiment, each node in the data structure includes a document component identified within the first document. In still another embodiments, the document import engine 1306 provides functionality for searching the data structure; for example, by searching for text in the document components within each node or by searching for text within metadata associated with a node.

In one embodiment, metadata is stored in a node in the data structure. In another embodiment, metadata includes a tag. For example, a user may generate a tag indicating a type of data stored by a node (“License Grant”, or “keep in mind”). In another embodiment, tags can be tagged; for example, a user may indicate that the user knows a tag generated by another member of the user's community by a different name. In still another embodiment, the metadata may be used by the document assembly engine 1310 in determining which nodes to access in generating a second document. In some embodiments, metadata associated with a first node is stored in a second node containing at least one of: an enumeration of nodes tagged by the metadata and a metadata identifier.

In one embodiment, the system includes at least one data item. In another embodiment, the data item stores data (e.g., text or multimedia). In still another embodiment, the data item is associated with a unique identifier, which may, for example, be generated by using a hashing algorithm such as SHA-1. In another embodiment, the data item is associated with metadata; for example, and without limitation, metadata may include an identification of an author of the data item or a date and time of creation. For example, and in one embodiment, the data item is stored within a node in the data structure and contains a pointer to a second node in the data structure containing the metadata. In yet another embodiment, the data item is associated with an identification of a parent node.

In one embodiment, the data item stores a field containing at least one of: data (e.g., a string of characters) and an identification of a second field. In another embodiment, the data item is a list containing at least one node storing at least one of: i) data and ii) a unique identifier of the field; such a data item may be referred to as a “table”. In still another embodiment, the data item is a list containing a unique identifier and a table; such a data item may be referred to as a “binder”. A binder may contain an identifier. In one embodiment, the identifier of the binder is pre-pended to a field referenced in the binder. In some embodiments, the binder displays data identified as having a pre-determined priority level. In other embodiments, the binder displays data used in rendering documents. In some embodiments, a plurality of binders is generated, each of which represent a person or other item, and have at least one data page of descriptive information and represent the relationships among the different items.

In one embodiment, the data item stores text and an enumeration of other data items associated with the text. For example, the data item may store a comment about a second data item and store an identification of the second data item. In another embodiment, the text stored by the data item is a tag or other metadata about a second data item. In still another embodiment, the data item stores an identification of one or more binders; such a data item may be referred to as a “tree”. In some embodiments, a “tree” data item stores an identification of one or more other trees.

In one embodiment, the document import engine 1306 retrieves a word processing document (e.g., a MICROSOFT WORD document). In another embodiment, the document import engine 1306 retrieves a link (e.g., a Uniform Resource Locator) providing access to the first document. In one embodiment, the document import engine 1306 retrieves text contained within the first document and populates a field within a table or worksheet with the retrieved text.

In one embodiment, the document import engine 1306 identifies at least one component within the first document by dividing the first document into sections (also referred to herein as fields). In another embodiment, the document import engine 1306 parses the first document, identifying semantic units within the first document as different fields. For example, and without limitation, the document import engine 1306 may identify different sections within an outline, different portions of code within a document including hypertext markup language (e.g., identifying the text within a set of <li> tags as one field and the text within a set of <p> tags as another field), or different sections of text based on punctuation (e.g., identifying the text before each period as a separate field). In still another embodiment, the document import engine 1306 copies the text within an identified section of the first document into a node in a data structure. The node may be referred to as a Field, and the text within the node may be referred to as Field Content. In yet another embodiment, the document import engine 1306 names the node; the name may be referred to as a Field Label. In some embodiments, the document import engine 1306 deletes the copied text from the first document. In one of these embodiments, the document import engine 1306 replaces the copied text with a reference to the Field Label or other identifier of the location of the node containing the original text. After the document import engine 1306 has identified each section with the first document, copied out the text from the section, and replaced the text with a Field Label, what remains is an outline (which may be referred to as a nested list outline) including identifiers of the nodes to which text was copied. The document import engine 1306 may generate an arbitrary identifier for the identified section (e.g., “6.1.1”); a user may later replace such an identifier with a meaningful name (e.g., “arbitration clause”).

In other embodiments, the document import engine 1306 incrementally automates a document. In one of these embodiments, a user edits text so that a section of the text to be copied into a node is replaced with a Plug, or identifier for the copied text. For example, the user may review a sentence (e.g., “long string of text with different semantic, meaning-based phrases”), select a section of the text (e.g., “semantic, meaning-based”), and create an identifier for the selection (e.g., GoodAdjectives), resulting in a revised version of the text (e.g., “long string of text with different {{GoodAdjectives}} phrases). The text from the section is copied into a new Field with the same Field Label as the Plug. In one embodiment, if the user later modifies the text (e.g., so that it reads “long string of text with different assorted phrases”), the modified version is saved to a second node (e.g., Dif.1.new=assorted); the first node may be renamed (e.g., Dif.1.old=semantic, meaning-based). The process of saving the section and creating the identifier may be saved as a macro or script that can be executed on other imported texts. In one embodiment, the methods and systems described herein provide functionality for summarizing and assuring the conformity of semantic units of a whole text where a reader delimits portions and replaces the portion of text with a field indication that has meaning for the reader or a subsequent reader and creates a field whose content is the removed portion of text and whose label is the meaningful field indicator.

In one embodiment, a single data structure contains all the documents of the community and may contain all the documents of a plurality of communities. In such an embodiment, a member of a community may identify portions of text that are standard components within documents for that community; furthermore, a member of a first community collaborating on a document with a member of a second community may view a standard component for the document within the first community as well as the corresponding standard component within the second community. Members of either community may accept other communities' standards, incorporating those standards into their own communities, or distribute their own standards into other communities. Such an embodiment may result in improved efficiency and collaboration between members of a community and/or between communities.

In some embodiments, before collaborating with members of other communities, members of a first community may establish access controls over portions of the data structure containing nodes relating to documents from the first community. For example, although a single data structure contains all documents from all communities, a portion of the data structure (a parent node and set of child nodes, for example) may relate to certain documents from within one community, and a member of the community may modify access rights allowing greater—or less—rights to members within the community and to members of other communities.

In other embodiments, there may be multiple data structures storing the data structures for a particular community or subset of a community. In one of these embodiments, by way of example, a database stores all of the data relating to all of the documents generated within a community and copies of the database containing a subset of the data is distributed to subsets of the community. By way of example, an executive of a company may decide to generate a copy of the database for use by a human resources (HR) department in which only HR-related document data is shown; leveraging the granular access control functionality available within the methods and systems described herein, the executive may provide a customized view of the company's data to the HR department members. As a further example, an employee may have a second copy of the database containing data relating to documents the employee works on as part of his or her job functionality and containing data relating to documents concerning the employee's HR files, but not the entire set of HR-related documents that the HR department has access to within the first copy of the database. Different copies of the databases may be modified independently, resulting in different versions of data. A user who has access to data that has been modified in one database may receive an alert of the modification and have the option of synchronizing his or her copy of the data to the modified version.

In some embodiments, a list of binders is used to version binders; such a list may be referred to as a “chron”. In one of these embodiments, each new version of a binder is added to the list of binders such that the fields in the new version override the fields in the prior versions of the binder. In another of these embodiments, saving modified text saves the modified data to a new binder that is added as a new version in the chron. In some embodiments, a list of chrons is referred to as a tree. By way of example, a user may have access to a tree listing each chron that the user is authorized to access, the chron leading directly or indirectly to the document data for one or more documents that the user is authorized to access.

In one embodiment, a node in the data structure is versioned; when a member of a community requests that the system modify the text contained within the node, the document import engine 1306 creates a second node containing the modification. For example, the document import engine 1306 may generate a new chron (a new list of binders), and a new binder (list of any other binders and an unordered list of fields, referred to as a table) within the new chron, and a new tree within the binder (e.g., list of items, analogous to folders). In other embodiments, “write-to-top” versioning is implemented and, in contrast to the versioned modification which is created in a new chron is generated, a second version of the chron is created—not a new chron altogether. In one of these embodiments, a modified version of the text contained in a first node is saved in a second node, which is given a higher location in the same data structure; the second node may be given a lower location in the data structure as subsequent nodes containing additional modifications are generated. Whether a new chron is generated or a new version of an existing chron is generated may depend on the type of user requesting the modification—in some embodiments, a modification for a user with a certain level of authorization results in generation of a new version of an existing chrons while a modification for a user with a default level of authorization results in generation of a new chron.

In some embodiments, the document import engine 1306 voids the contents of a node without deleting the node itself. In other embodiments, a node is designated as a node containing notes (e.g., a “sandbox area” in which members of the community may make notes); such a node may be exempted from versioning. In still other embodiments, the document import engine 1306 provides a tool allowing a user to indicate whether or not a node should be versioned.

In embodiments where modifications to nodes are allowed, instead of creating new nodes with modified versions of node contents, a document may be presented to the user displaying the contents of a modified node (e.g., an updated version of a chron).

In one embodiment, the document import engine 1306 includes functionality for distributing at least one node of the data structure to a plurality of members of the community. In another embodiment, the document import engine 1306 transmits a copy of at least one node to a client 1302a (e.g., to a computer used by a member of the community) for storage in a cache on the client 1302a; in this way, the contents of the at least one node are available to the member of the community when it is requested. Nodes may be encrypted before transmission. Alternatively, a hash may be generated providing the client 1302 with information identifying a location of the node for later retrieval. In some embodiments, the document import engine 1306 generates a copy of a database storing the data structure and provides the copy to the member of the community.

In one embodiment, the document tagging engine 1308 receives data from one or more members of the community indicating which, if any, document components imported by the document import engine 1306 should be identified as standard components within the community. In another embodiment, the document tagging engine 1308 receives, from one or more members of the community, annotations providing meaningful names to a document component. In still another embodiment, the document tagging engine 1308 receives, from one or more members of the community, annotations to a document component.

In one embodiment, the document tagging engine 1308 receives, from each of a plurality of members of the community, an annotation for association with the at least one document component. For example, the document tagging engine 1308 may receive, via a user interface, an indication from a majority of members of the community that a particular component is a standard within the community. In another embodiment, the document tagging engine 1308 associates metadata with a document component when it receives indications from a number of members equal to or surpassing a threshold for tagging components. For example, an administrator may indicate that a certain percentage of a community need to identify a component as a standard, or identify a meaningful name for the component, before the document tagging engine 1308 may tag the component as such. In still another embodiment, the document tagging engine 1308 associates metadata with the document component whenever it receives indications from any member of the community regarding the document component. In some embodiments, the metadata includes an identification of the member of the community that provided the metadata.

In some embodiments, the document tagging engine 1308 receives, from the first member of the community, an identification of a modification of the at least one document component and an identification of an annotation to be associated with the at least one document component. In one of these embodiments, the document tagging engine 1308 transmits the identification of the modification to the document import engine 1306. In another of these embodiments, the document import engine 1306 generates a second node within the data structure, the second node containing a modified version of the at least one document component. In another of these embodiments, the document tagging engine 1308 associates the annotation with the second node, e.g., the annotation including an identification of the modified at least one document component as a standard in the community or providing a meaningful name for the at least one document component, or providing a synonym for the at least one document component. In still another of these embodiments, the document tagging engine 1308 associates metadata with the second node, the metadata including an identification of the member of the community that suggested the modification. In other embodiments, the document tagging engine 1308 generates an alert informing the first member of the community that the modification was made. In still other embodiments, the document tagging engine 1308 generates an alert informing a member of the community that previously edited the component that a new modification has been made.

In one embodiment, the document tagging engine 1308 provides a user interface allowing a member of the community to annotate a node in the data structure. In another embodiment, the document tagging engine 1308 provides a user interface allowing a member of the community to annotate nodes in the data structure. For example, a member of the community may create a tag containing text providing information for other members of the community who review the node (e.g., a “notes to the next user” node); when other members of the community review the node, they may be reminded to review the tag, to respond to the tag, or to acknowledge having reviewed the tag.

The document assembly engine 1310 receives requests for document generation, the requests including an indication of a component identified by an annotation to be included in the generated document. By way of example, the request may include an identification of a standard component to be included in the generated document, or a meaningful name provided in an annotation to a document component. As another example, the request may indicate that the document should include a document component associated with an annotation that identifies the meaningful name of the document component as “arbitration clause”; the document assembly engine 1310 may search for a node associated with an annotation that the meaningful name of the node is “arbitration clause” (for example, by searching a table in a binder for a tag that includes the annotation). Although the specific text contained in a node identified by the search may or may not include the exact phrase “arbitration clause” (it may, for example, include text such as “clause regarding arbitration” or contain the arbitrary name originally generated for it by the document import engine 1306), the component will be included in the generated document.

In one embodiment, the document assembly engine 1310 receives, from the second member of the community, content to include in the second, generated document. In another embodiment, the document assembly engine 1310 receives, from the second member of the community, metadata including an identification of a type of content to include in the second document. In still another embodiment, the document assembly engine 1310 receives, from the second member of the community, an identification of a node within the data structure to include in the second document. In yet another embodiment, the document assembly engine 1310 generates a second node in the data structure containing at least one document component of the second document. In some embodiments, the document assembly engine 1310 generates a document as described above in connection with FIGS. 1A-12.

In one embodiment, the document assembly engine 1310 includes a recommendation engine (not shown), which recommends, to the second member of the community, inclusion in the second document of a second node within the data structure. In another embodiment, the document assembly engine 1310 may review a request from a user for generation of a second document, the request including a request for inclusion of at least one type of document component and compare the request to other users' requests for generation of documents containing requests for inclusion of the same component type. The document assembly engine 1310 may analyze the contents of the documents generated in response to those other requests and determine what additional component types were included. The document assembly engine 1310 may recommend one or more of the additional component types to the user for inclusion in the requested document; for example, the document assembly engine 1310 may generate a user interface element for display to the second member of the community listing recommended alternatives or additions to the document. The document assembly engine 1310 may also identify additional component types by examining contents of documents generated by other users in the same community as the current user. In still another embodiment, the document assembly engine 1310 may indicate to the user that a requested component type is unusual in documents generated by users of similar communities or in similar types of documents.

In one embodiment, the document assembly engine 1310 generates a cover sheet for the second document; for example, the cover sheet may list a summary of the different types of nodes included in the second document. In another embodiment, the cover sheet may be customized to present different views of the document to different members of the community. In still another embodiment, when a new version of a node is generated, a new cover sheet is generated as well. For example, and without limitation, a cover sheet may be customized to include all of the fields included in the document, only top fields, only fields that are actually used, only fields tagged with particular tags, and other customizations.

In one embodiment, a series of stages or separate uses of materials may be achieved and represented by taking a binder from a previous stage and using it as a page in a second binder that corresponds to the next stage or use. In that next binder, an additional data page with a higher priority is added, and the desired modifications are made by fields in that higher priority data page. This creates a plurality of binders each of which corresponds to a different stage or use, creating a network of items or events that reference one another.

In one embodiment, the methods and systems described herein provide functionality for editing a document assembled according to the methods described above wherein the user is presented on a screen with the resulting document but with hidden or barely visible metadata that allows the user to modify the presented text and have the new text replace the field contents of the field that was the source of the edited text. In another embodiment, the user has the choice to save the new text as a new field with the same name as the original field, but in a higher priority data page. In still another embodiment, the new text is saved to the highest priority data page. In some embodiments, the new text is saved to a new highest priority page created for the editing session.

In another embodiment, interim saves are made by creating an additional field with a variant on the name that indicates it is a version of that field. In such an embodiment, the highest priority variant (e.g., the highest numbered version) is treated as the active version of the field. In yet another embodiment, the user may add a new version of a field that points to an older version of a field or another field.

In one embodiment, the methods and systems described herein provide a record of transactions amongst members of one or more communities. For example, through the use of a single data structure containing all documents amongst all communities, as well as containing a record of modifications to each of the documents (due to the creation of a new node for every modification), the data hierarchy stores a record of the document generation process for a single document, but also for all documents generated as part of a transaction or other collaboration amongst members of one or more communities. In another embodiment, a new node is generated at the completion of the document generation or transaction process; for example, when both members sign an agreement or other document, a new node commemorating the signature may be generated.

In some embodiments, the datastore 1312 may include hardware and/or software to store data structures used by the system 1300.

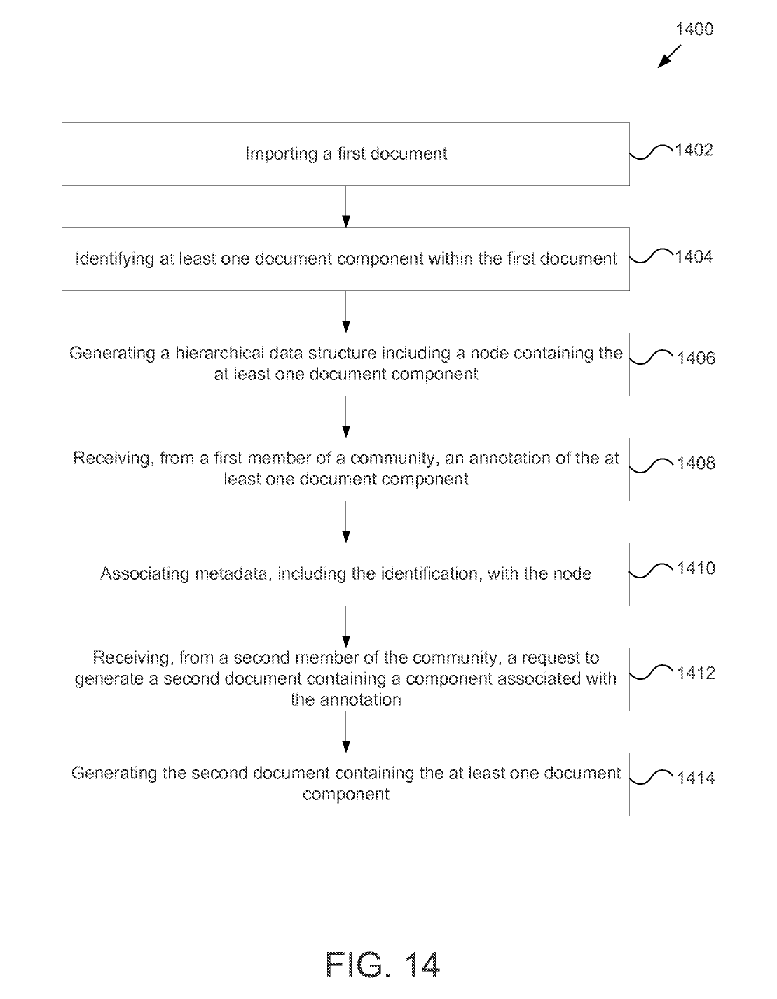

FIG. 14 is a diagram of an example of a method 1400 for identifying a standard document component in a community and automatically generating a document containing the standard document component, according to some embodiments. The method 1400 is discussed in the context of the system 1300 of FIG. 13. Other structures may perform the steps of the method 1400 without departing from the scope and the substance of the inventive concepts described herein. The method 1400 may have steps other than those illustrated in FIG. 14. Steps of the method 1400 may have sub-steps that are not illustrated in FIG. 14. Moreover, it may be possible to practice the method 1400 using fewer steps than those illustrated in FIG. 14 without departing from the scope and the substance of the inventive concepts described herein.

Step 1402 of the method 1400 comprises importing a first document. In the example of FIG. 13, the document import engine 1306 may import a first document. The document import engine 1306 may receive the first document from one or more of the client 1302a and the client 1302b. In some embodiments, the document import engine 1306 may import the first document from storage located on the remote machine 1304 (e.g., from the datastore 1312) or communicatively coupled to the remote machine 1304. In various embodiments, the document import engine 1306 may import the first document from a network location, such as a trusted network location (i.e., network storage located behind a firewall or corporate Ethernet barrier), or the open Internet.

Step 1404 of the method 1400 comprises identifying at least one document component within the first document. In the example of FIG. 13, the document import engine 1306 may parse the first document for document components. Step 1406 of the method 1400 comprises generating a hierarchical data structure including a node containing the at least one document component. In the example of FIG. 13, the document import engine 1306 may generate a hierarchical data structure that includes a node that in turn contains the at least one document component.

Step 1408 of the method 1400 comprises receiving, from a first member of a community, an annotation of the at least one document component. In the example of FIG. 13, the document tagging engine 1308 may receive an annotation of the at least one document component from the client 1302a. Step 1410 of the method 1400 comprises associating metadata, including the identification, with the node. In the example of FIG. 13, the document tagging engine 1308 may associate metadata, including the identification, with the node.

Step 1412 of the method 1400 comprises receiving, from a second member of the community, a request to generate a second document containing a component associated with the annotation. In the example of FIG. 13, the document assembly engine 1310 may receive, from the client 1302b, a request to generate a second document containing a component associated with the annotation. Step 1414 of the method 1400 comprises generating the second document containing the at least one document component. In the example of FIG. 13, the document assembly engine 1310 may generate the second document that contains the at least one document component. In various embodiments, the document assembly engine 1310 may store the second document in the datastore 1312.

FIG. 15 depicts an example of a digital device 1500 according to some embodiments. The digital device 1500 comprises a processor 1502, a memory system 1504, a storage system 1506, a communication network interface 1508, an I/O interface 1510, and a display interface 1512 communicatively coupled to a bus 1514. The processor 1502 may be configured to execute executable instructions (e.g., programs). In some embodiments, the processor 1502 comprises circuitry or any processor capable of processing the executable instructions.

The memory system 1504 is any memory configured to store data. Some examples of the memory system 1504 are storage devices, such as RAM or ROM. The memory system 1504 may comprise the RAM cache. In various embodiments, data is stored within the memory system 1504. The data within the memory system 1504 may be cleared or ultimately transferred to the storage system 1506.

The storage system 1506 is any storage configured to retrieve and store data. Some examples of the storage system 1506 are flash drives, hard drives, optical drives, and/or magnetic tape. In some embodiments, the digital device 1500 includes a memory system 1504 in the form of RAM and a storage system 1506 in the form of flash data. Both the memory system 1504 and the storage system 1506 comprise computer readable media which may store instructions or programs that are executable by a computer processor including the processor 1502.

The communication network interface (com. network interface) 1508 may be coupled to a data network (e.g., data network 1504 or 1514) via the link 1516. The communication network interface 1508 may support communication over an Ethernet connection, a serial connection, a parallel connection, or an ATA connection, for example. The communication network interface 1508 may also support wireless communication (e.g., 802.15 a/b/g/n, WiMAX). It will be apparent to those skilled in the art that the communication network interface 1508 may support many wired and wireless standards.

The optional input/output (I/O) interface 1510 is any device that receives input from the user and output data. The optional display interface 1512 is any device that may be configured to output graphics and data to a display. In one example, the display interface 1512 is a graphics adapter.

It will be appreciated by those skilled in the art that the hardware elements of the digital device 1500 are not limited to those depicted in FIG. 15. A digital device 1500 may comprise more or less hardware elements than those depicted. Further, hardware elements may share functionality and still be within various embodiments described herein. In one example, encoding and/or decoding may be performed by the processor 1502 and/or a co-processor located on a GPU.

Although described herein in the context of document generation for, by way of example, drafting of documents, it should be understood that the methods and systems described herein may be implemented to generate other types of documents. In some embodiments, a record of transactions provides a record of work done by a member of the community; for example, a member doing research or technical work and generating a document managed by the systems described herein may maintain a record of work such as an inventor's journal that tracks when the individual did what work and annotated with additional details of the project and any collaborators. In other embodiments, a record of transactions provides a non-financial bookkeeping system. In still other embodiments, the methods and systems described herein provide a distributed means for collaborating on documents. In one of these embodiments, for example, rather than utilize a third-party, potentially insecure or unreliable, service in which documents are stored remotely, an organization may implement the methods and systems described herein to provide users with access to document assembly and collaborative editing solutions. In further embodiments, the methods and systems described herein may be implemented by an organization seeking to generate new documents complying with industry standards—for example, without limitation, a city or state government may implement the methods and systems described herein to generate forms that comply with federal requirements.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, Python, Ruby, Scala or in any byte code language such as JAVA. The software programs may be stored on or in one or more articles of manufacture as object code.

Having described certain embodiments of methods and systems for identifying, and automatically generating documents containing, standard document components, it will now become apparent to one of skill in the art that other embodiments incorporating the concepts of the disclosure may be used.

1. A system, comprising:
a document import engine configured to import a first document, identify at least one document component within the first document, and generate a hierarchical data structure including a node containing the at least one document component;
a document tagging engine configured to receive, from a first member of a community, an annotation of the at least one document component, and associate metadata, including the identification, with the node; and
a document assembly engine configured to receive, from a second member of the community, a request to generate a second document containing a component associated with the annotation, and generate the second document containing the at least one document component.

2. The system of claim 1, wherein the document tagging engine is configured to receive, from each of a plurality of members of the community, an identification of the at least one document component as a standard document component.

3. The system of claim 1, wherein the document tagging engine is configured to associate metadata with the at least one document component upon receiving, from each of a plurality of community members, an identification of the at least one document component as a standard document component.

4. The system of claim 1, wherein the document tagging engine is configured to associate the metadata with the at least one document component, the metadata including an identification of the first member of the community.

5. The system of claim 1, wherein the document tagging engine is configured to receive, from the first member of the community, an identification of a modification of the at least one document component and an identification of the modified at least one document component as a standard document component.

6. The system of claim 5, wherein the document import engine is configured to generate a second node within the hierarchical data structure, the second node containing a modified at least one document component.

7. The system of claim 6, wherein the document tagging engine is configured to associate additional metadata with the second node, the additional metadata including an identification of the first member of the community.

8. The system of claim 6, wherein the document tagging engine is configured to associate additional metadata with the second node, the additional metadata including an identification of the modified at least one document component as a standard in the community.

9. The system of claim 1, wherein the document import engine is configured to distribute at least one node of the hierarchical data structure to a plurality of members of the community.

10. The system of claim 1 wherein the document import engine is configured to search, by at least one member of the community, the hierarchical data structure for the node.

11. The system of claim 1, wherein the document assembly engine is configured to receive, from the second member of the community, content to include in the second document.

12. The system of claim 1, wherein the document assembly engine is configured to receive, from the second member of the community, additional metadata including an identification of a type of content to include in the second document.

13. The system of claim 1, wherein the document assembly engine is configured to receive, from the second member of the community, an identification of a node within the hierarchical data structure to include in the second document.

14. The system of claim 1, wherein the document assembly engine is configured to generate a second node in the hierarchical data structure containing at least one document component of the second document.

15. The system of claim 1, wherein the document assembly engine is configured to recommend to the second member of the community inclusion, in the second document, of a second node within the hierarchical data structure.

16. The system of claim 1, wherein the document tagging engine further comprises a user interface allowing the first member of the community to identify the node in the hierarchical data structure as a standard component in the community.

17. The system of claim 1, wherein the document tagging engine further comprises a user interface allowing the first member of the community to annotate the node in the hierarchical data structure.

18. A method, comprising:
importing a first document;
identifying at least one document component within the first document;
generating a hierarchical data structure including a node containing the at least one document component;
receiving, from a first member of a community, an annotation of the at least one document component;
associating metadata, including the identification, with the node;
receiving, from a second member of the community, a request to generate a second document containing a component associated with the annotation; and
generating the second document containing the at least one document component.
